(19) United States
(12) Patent Application Publication
(10) Pub. No.: US 2005/0215449 A1
(43) Pub. Date: Sep. 29, 2005

(54) Textile care product

(76) Inventors: Josef Penninger, Hilden (DE); Christian Block, Brussels (BE); Evelyn Langen, Moenchengladbach (DE); Konstanze Mayer, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 11/135,123

(22) Filed: May 20, 2005

Related U.S. Application Data
(63) Continuation of application No. PCT/EP03/12484, filed on Nov. 8, 2003.

(30) Foreign Application Priority Data
Nov. 20, 2002 (DE) 102 53 975.8

(51) Int. Cl. C11D 1/00

(52) U.S. Cl. 510/267

(57) ABSTRACT

Textile care agents containing optionally graft copolymers of (a) ethylenically unsaturated carboxylic acids and (b) carbhydrates. The agents reduce fluffing of textiles in textile treatment processes.

### CROSS REFERENCE OF RELATED APPLICATIONS

This application is a continuation of under 35 U.S.C. § 365(c) and 35 U.S.C. § 120 of international application PCT/EP2003/012484, filed on Nov. 8, 2003. This application also claims priority under 35 U.S.C. § 119 of DE 102 53 975.8, filed Nov. 20, 2002, which is incorporated herein by reference in its entirety.

### BACKGROUND OF THE INVENTION

The invention concerns a textile care agent containing a copolymer of unsaturated carboxylic acids and/or their salts with carbohydrates, as well as a washing method for washing textiles using the textile care agent in an ordinary household washing machine. The invention further concerns the use of the textile care agent to reduce creasing, improve ironing properties, and decrease pilling.

Modern textile cleaning places considerable demands on the laundry items that are being cleaned. Frequent washing of garments in a washing machine and subsequent drying in a clothes dryer, for example, is associated with a high level of mechanical stress on the woven fabric. Frictional forces often result in damage to the textile fabric, detectable as fluffing and pilling. With each washing and drying cycle, but also as the garments are worn, further abrasion and/or breakage of tiny fibers on the surface of the textile fabric takes place. Conventional textile cleaning agents are not capable of decreasing this damage to the woven fabric, or merely attempt to eliminate textile damage that has occurred.

WO 99/16956 A1 describes the elimination of fluff or pills by using cellulases. The cellulases digest the microfibers projecting from the textile fabrics and thus ensure a smooth and therefore pill-free textile surface.

A further great disadvantage of mechanical stress on textile fabrics and the pilling associated therewith is the creation of creased textile surfaces that are undesired by the user, and the formation of rough surfaces. Both the rough textile surfaces and the creasing caused in the woven fabrics result in a considerable degradation in the smoothing properties of irons or other textile flattening apparatuses. The outlay for flattening rough and creased textiles involves not only greater physical exertion, but also a considerably greater expenditure of time. The existing art contains approaches to improving ironing properties chiefly in the field of post-treatment agents. WO 00/7 7134, for example, discloses the use of oxidized polyolefins in conditioner formulations to improve ironing properties.

The utilization of carbohydrate-modified copolymers and their use in textile treatment agents is already known from the existing art. WO 97/00272 Al describes a polymer that comprises at least one carbohydrate unit and at least one 2-hydroxy-2-carboxyethylene unit. These polymers are produced by polymerizing at least one vinyl monomer A that is chiefly an α-halogen acrylic acid, and at least one further vinyl monomer B, in the presence of at least one (optionally modified) carbohydrate. The polymers are used in bleach-containing agents for textile treatment and paper bleaching.

WO 96/37530 A1 describes water-soluble graft copolymers of monosaccharides, oligosaccharides, and polysaccharides and their derivatives, which are obtainable by radical-initiated copolymerization of A) monomer mixtures of a) more than 40-100 wt % of at least one α-β-unsaturated aldehyde; b) 0-60 wt % of unsaturated monomers, different from a), that are copolymerizable with a); and c) 0-5 wt % of at least two monomers having ethylenically unconjugated double bonds in the molecule, in the presence of B) mono-, oligo-, or polysaccharides and C) one or more oxidizing agents. The polymers are used, inter alia, in washing agents as builders and cobuilders having good incrustation-inhibiting effects.

WO 94/01476 describes graft copolymers of mono-, di-, and oligosaccharides that are obtainable by radical graft copolymerization of a monomer mixture of
A) 45-96 wt % of at least one unsaturated monocarboxylic acid;
B) 4-55 wt % of at least one monoethylenically unsaturated sulfonic acid-group-containing monomer;
C) 0-30 wt % of a water-soluble unsaturated compound that is modified with 2-50 mol alkylene oxide;
D) 0-45 wt % of at least one further water-soluble radically polymerizable monomer; and
E) 0-30 wt % of other radically polymerizable monomers insoluble in water.

Applications for the graft copolymers include additives in washing and cleaning agents.

EP 0 465 287 A1 discloses graft polymers based on polysaccharides that are at least partially biodegradable and comprise a polydextrose, having an average molecular weight of less than 10,000 g/mol, that is grafted with a water-soluble unsaturated monomer. The graft polymers are used in washing agents because of their builder properties.

It is the object of the present invention to make available a textile care agent that greatly reduces the fluffing and pilling of textile fabrics in the context of textile care.

It has been found, surprisingly, that the use of certain carbohydrate-based copolymers in textile care agents allows the fluffing and pilling of textile fabrics to be greatly reduced.

The subject matter of the present invention is therefore, in a first embodiment, a textile care agent containing a copolymer obtainable by copolymerization of a component (a) encompassing one or more ethylenically unsaturated carboxylic acid(s) and/or their salts, with a component (b) encompassing carbohydrates, optionally in the presence of component (c) encompassing one or more oxidizing agents; and additionally, optionally, one or more complexing agents.

In the context of this invention, “textile care agents” are understood to mean both washing and cleaning agents and pretreatment agents, as well as agents for conditioning textile fabrics such as delicate fabric washing agents, and post-treatment agents such as conditioners.

“Conditioning” is to be understood for purposes of this invention as the brightening treatment of textile fabrics, materials, yarns, and woven fabrics. Conditioning imparts positive properties to the textiles, for example improved softness, enhanced shine and color brilliance, a fresh scent, and a decrease in creasing and static charge.

The textile care agent according to the present invention contains a copolymer as an essential component. The copolymer is obtained by copolymerization of a component (a), encompassing one or more ethylenically unsaturated carboxylic acid(s) and/or their salts, with a component (b) encompassing carbohydrates, optionally in the presence of component (c) encompassing one or more oxidizing agents.

In the context of the present invention, ethylenically unsaturated carboxylic acid(s) and/or their salts, for example ethylenically unsaturated C₃-C₁₀ carboxylic acid(s), preferably C₃-C₆ carboxylic acids(s), particularly preferably α-β-unsaturated carboxylic acids, in particular α-β-unsaturated C₃-C₆ carboxylic acids(s), and/or their alkali and/or ammonium salts, as well as arbitrary mixtures thereof, have come to the fore as component (a).

Ethylenically unsaturated carboxylic acids usable according to the present invention as component (a), which can be provided as monomers for copolymerization, are acrylic acid, methacrylic acid, ethylacrylic acid, allylacetic acid and vinylacetic acid. Of this group of monomers, acrylic acid, methacrylic acid, their mixtures, and the sodium, potassium, or ammonium salts or their mixtures, are preferably used.

Also included among the monomers of group a) that can be used, if applicable, in the context of copolymerization are, for example, C₁ to C₆ alkyl and/or hydroxyalkyl esters of the aforesaid compounds, for example methyl acrylate, ethyl acrylate, n-butyl acrylate, methyl methacrylate, monomethyl maleate, diethyl maleate, hydroxyethyl acrylate, hydroxypropyl acrylate, hydroxybutyl acrylate, hydroxyethyl methacrylate, and hydroxypropyl methacrylate, as well as esters of acrylic acid and methacrylic acid with polyvalent alcohols, for example glycol diacrylate, glycerol triacrylate, glycol dimethacrylate, glycerol trimethacrylate, and polyols at least doubly esterified with acrylic acid or methacrylic acid, such as pentaerythritol and glucose.

Also possible as monomers of group a) are the amides and N-substituted alkylamides of the aforesaid compounds, for example acrylamide, methacrylamide, N-alkylacrylamides having 1 to 18 carbon atoms in the alkyl group, for example N-methylacrylamide, N,N-dimethylacrylamide, N-tert-butylacrylamide, N-octadecylacrylamide, maleic acid monoethylhexylamide, maleic acid monododecylamide, dimethylaminopropylmethacrylamide, and acrylamidoglycolic acid.

Also suitable as monomer a) are alkylaminoalkyl(meth)acrylates, for example dimethylaminoethyl acrylate, dimethylaminoethyl methacrylate, diethylaminoethyl acrylate, diethylaminoethyl methacrylate, dimethylaminopropyl acrylate, and/or dimethylaminopropyl methacrylate.

Suitable according to the present invention as (optionally modified) component (b) are carbohydrates that contain at least three carbon atoms and exhibit a polyol character, i.e. contain at least three hydroxy groups per carbon chain or ring, and are soluble, suspensible, or swellable in water.

“Carbohydrates” chiefly means natural saccharides or modification products thereof, i.e. saccharides that are obtained from animal or plant products (e.g. from the processing of milk, honey, or plant parts), or simple modification products thereof, for example enzymatically or chemically modified (e.g. by hydrolysis, hydrogenation, oxidation, partial etherification or esterification, and/or derivatization), provided the essential polyol nature of the saccharide is maintained. Synthetic saccharides can also be used, chiefly polymerization products of mono- and/or disaccharides such as those producible by polymerization in aqueous solution, but preferably the carbohydrates are natural saccharides or simple modification products thereof.

Advantageously possible as carbohydrates are oligo- or polysaccharides whose monomer units contain 4 to 7, preferably 5 or 6, carbon atoms. Possible modified carbohydrates are chiefly those carbohydrates in which one or two functional groups have been chemically modified, for example by alkylation,. e.g. with an unsubstituted or substituted low-molecular-weight alkyl, chiefly alkylation with unsubstituted C₁₋₄ alkyl, in particular methyl or butyl, carboxyalkylation, chiefly carboxymethylation (e.g. by reaction with chloroacetic acid), attachment of epoxides (e.g. ethylene oxide or propylene oxide) to yield oxyalkylation products, or reaction with (optionally substituted) chlorohydrins, or by acylation, e.g. with acyl radicals of low-molecular-weight carboxylic acids, chiefly of C₂₋₄ carboxylic acids, in particular acetyl, or derivatization, provided at least three hydroxy groups having carbohydrate character are present for each carbon chain or ring.

“Modification products” are also to be understood as cationically modified polysaccharides, for example starches reacted with 2,3,-epoxypropyltrimethylammonium chloride as described, for example, in U.S. Pat. No. 3,649,616.

Chemically modified polysaccharides also include, for example, carboxymethylcellulose, hydroxyethylcellulose, hydroxypropylcellulose, carboxymethylhydroxyethylcellulose, sulfoethylcellulose, carboxymethylsulfoethylcellulose, hydroxypropylsulfoethylcellulose, hydroxyethylsulfoethylcellulose, methylsulfoethylcellulose, and ethylsulfoethylcellulose.

Any desired oligo- or polysaccharies or simple modification products thereof, or mixtures thereof, are possible as carbohydrates.

Carbohydrates are, for example, starch, pectin, algin, chitin, chitosan, heparin, carrageenan, agar, gum arabic, tragacanth, karaya gum, ghatti gum, locust bean gum, guar gum, tara gum, inulin, xanthan, dextran, sucrose, nigeran, and pentosanes such as xylan and araban, whose principal constituents comprise D-glucuronic acid, D-galacturonic acid, D-galacturonic acid methyl ester, D-mannuronic acid, L-guluronic acid, D- and L-galactose, 3,6-anhydro-D-galactose, L-arabinose, L-rhamnose, D-glucuronic acid, D-xylose, L-fucose, D-mannose, D-fructose and D-glucose, 2-amino-2-deoxy-D-glucose and 2-amino-2-deoxy-D-galactose, and their N-acetyl derivatives.

Particularly suitable as oligosaccharides are open-chain or cyclic oligosaccharides such as lactose, maltose, cellobiose, raffinose, gentiobiose, trehalose, melezitose, dextrins, and cyclodextrins (α, β and/or γ), and their mixtures.

Particularly suitable among the carbohydrates that are present as polysaccharides are those that are soluble, suspensible, or swellable in water, chiefly starch polysaccharides and/or substantially linear polysaccharides that occur in starches, in particular amylose, and degradation products (preferably hydrolysis products) thereof, for example syrup or dextrins, as well as mixtures of such polysaccharides, and/or substantially linear other polysaccharides as well as branched polysaccharides such as celluloses, xylans, arabans, and galactans.

From an economic standpoint, it is particularly preferred to use, as the carbohydrates, polysaccharides that are suitable in particular for graft copolymerization. In a preferred embodiment of the present invention, starches, thermally and/or mechanically treated starch, oxidatively or hydrolytically degraded starch or oxidized enzymatically degraded starch, oxidized hydrolytically degraded or oxidized enzymatically degraded starches, and chemically modified starches are used as the carbohydrates.

In principle, all starches are suitable. Starches from corn, wheat, rice, tapioca, and in particular starch from potatoes, are preferred, however. Starches are practically insoluble in water and can be converted into a water-soluble form, in known fashion, by thermal and/or mechanical treatment or by enzymatic or acid-catalyzed degradation. The following compounds may be mentioned, for example, as starch degradation products that are obtainable by either oxidative, hydrolytic, or enzymatic degradation of starch: dextrins such as white and yellow dextrins, maltodextrins, glucose syrups, maltose syrups, hydrolysates having a high D-glucose content, starch saccharification products, as well as maltose and D-glucose and their isomerization product fructose.

It is particularly advantageous to use, as carbohydrates for the polymer to be utilized according to the present invention, starch components such as those that occur in ordinary starch flours (obtained e.g. from plant parts, such as legumes, cereals, tubers, hearts of palm, or algae), for example rice starch, corn starch, potato starch, tapioca starch, soy starch, guaran, carrageenan, carubin, agar, or ghatti gum, and mixtures thereof.

According to an advantageous embodiment of the invention, engineered starches, optionally purified and/or enzymatically modified, for example in the form of starch flours, are used as carbohydrates.

The method for producing the copolymer, or a mixture thereof, to be utilized according to the present invention is preferably performed in a suitable solvent, preferably in a polar solvent, in particular in an aqueous medium. In a preferred embodiment, polymerization is accomplished at pH values that are preferably in the acid range, particularly preferably below a pH of 6, in particular below a pH of 5, and especially within a pH range from 0.1 to 4. Aqueous media having the aforementioned pH ranges have proven advantageous in the context of the present invention.

The pH value is advantageously set using a strong mineral acid, e.g. phosphoric acid or preferably sulfuric acid, or a strong carboxylic acid, e.g. citric acid.

Polymerization of the monomers of component (a) with the carbohydrates (component (b)) is preferably performed, depending on the nature, concentration, and pretreatment of the components, so that the reaction mixture is present as a true or colloidal solution. The carbohydrates can be present in suspended or swollen, dispersed form, but it is advantageous for the mixture to be stirrable.

In a preferred embodiment, component (b) is at least partially soluble in the reaction medium. Component (b) can therefore preferably already be a modification product of the natural carbohydrates, for example products of the metabolism of microorganisms, which ensure that the carbohydrates are already soluble and/or dispersible in water. The aforementioned polymerization can, for example, be preceded by an enzymatic pretreatment, for example of oligo- or polysaccharides or pectins, including in one working step in a single reaction vessel. The enzymatic conversion can then usefully be terminated by the addition of acids.

The molar ratio of component (a) to component (b) can fluctuate over a wide range, advantageously so that on average, at least one fundamental unit of component (a) is present in the end product for each fundamental carbohydrate molecule.

For each mole of carbohydrate unit, usually at least 1, preferably 1.5 to 40, particularly preferably 2.5 to 30, in particular 3.5 to 15, and extremely preferably 5 to 12 moles of component (a) are used A “carbohydrate unit” in the (optionally modified) initial carbohydrate is understood to be an open-chain or preferably cyclic, optionally modified, carbohydrate group that carries, for each group of contiguous carbon atoms, at least three hydroxy groups as substituents and, if it is cyclic, contains a (preferably furanosidic or pyranosidic) oxygen atom as ring member, in which context the carbohydrate units can optionally be bridged to one another via oxygen (e.g. a glucoside ring such as that occurring in oligo- or polyglucosides).

In a particularly preferred embodiment, the copolymer to be utilized according to the present invention is present as a graft copolymer. Graft copolymers are produced, for example, when monomers are (preferably radically) polymerized in the presence of previously produced polymers that serve as macroinitiators and thus simultaneously as graft substrates. In the case of the graft copolymers of the present invention that are preferably to be utilized, the carbohydrates representing component (b) constitute the graft substrate onto which the monomers of component (a) can be grafted. In the context of the present invention, graft copolymers that have a high graft density and short grafts have proven suitable in particular for the effect of fluff reduction and reduced creasing. The average degree of substitution, i.e. the number of positions in a carbohydrate unit that are substituted with components (a), is greater than 1.5, preferably greater than 2, and in particular greater than 2.5. Also particularly suitable are those graft copolymers in which, on average, each grafting site comprises more than one monomer, preferably more than 2 monomers, particularly preferably 2.5 to 5 monomer units of component (a). The degree of substitution and the length of the graft chain can be determined, for example, by NMR measurements by comparison to appropriate standards.

The reaction temperature for polymerization chiefly assumes values in the range from 20 to 150° C., advantageously 40 to 100° C., preferably 60 to 98° C, in particular 70 to 90° C.

In particular for the production of graft copolymers to be utilized according to the present invention, it has proven advantageous to have the polymerization proceed in the presence of component (c) encompassing one or more oxidizing agents.

“Oxidizing conditions” are understood to mean here the use of a component (c) preferably within a weight ratio of component (c) to components (a)+(b) from (1:100) to (1:1), particularly preferably from (1:70) to (1:2), in particular from (1:50) to (1:10), component (c) preferably having sufficient oxidizing power to effect an oxidation of carbonyl groups and an oxidation and degradation of the component (b), preferably a polysaccharide, that is used, and thus to initiate a polymerization, proceeding from component (b), of the reaction mixture.

All oxidizing agents familiar to one skilled in the art are possible as component (c). These include, among others, hydrogen peroxide, hypochloride, nitrogen dioxide, nitrogen tetroxide, nitric acid, ammonium or potassium peroxydisulfate and/or periodate. Hydrogen peroxide is preferably used as the oxidizing agent. The hydrogen peroxide can be used as such or as a compound that gives off H₂O₂, e.g. as potassium peroxide, or in the form of an organic per- acid, but it is preferably used directly as H₂O₂. Mixtures of several oxidizing agents are also possible. In a preferred embodiment, the oxidizing agent is free of transition metal ions.

The respective reactants and optionally component (c) can be introduced all at once or gradually; good reaction control can be achieved, for example, by gradual introduction of component (c). The degree of polymerization of components (a) and (b) that are used can be controlled, for example, in a manner familiar to one skilled in the art, by way of the quantity of component (c).

Because the copolymers to be utilized according to the present invention are advantageously obtainable by way of a radical polymerization, it may be useful to perform the copolymerization in the presence of radical-forming initiators or under the influence of suitable high-energy radiation. The following initiators or catalysts are, in particular, possible: water-soluble azo compounds, for example 4,4′-azo-bis-(4-cyanopentanoic acid), 2,2′-azo-bis(2-aminodipropane)dihydrochloride, or azobisisobutryic acid dinitrile, redox systems or peroxy compounds (in particular diacetyl peroxide, ditert-butyl peroxide, tert-butyl hydroperoxide, tert-butyl perpivalate, cumol hydroperoxide, benzoyl hydroperoxide, dibenzoyl peroxide, diisopropylperoxydicarbonate, sodium perborate, hydrogen peroxide, or ammonium or alkali-metal peroxydisulfate).

In a preferred embodiment, the copolymerization, preferably taking place in an acid environment, can have suitable bases added for neutralization and/or hydrolysis and/or salt formation.

Suitable as basic components are, for example, ammonia, alkali metal hydroxides, and/or low-molecular-weight mono-, di-, or trialkylamines or -alkanolamines, in particular triethanolamine or triisopropanolamine, and/or buffering alkali metal salts, among which alkali metal hydroxides (lithium, sodium, or potassium hydroxide) are preferred, in particular sodium hydroxide and potassium hydroxide.

The length and distribution of the (co)polymer chains can be governed by selecting the quantitative relationships and reaction conditions. The copolymers, for example, can contain component (a) in added-on or added-in fashion in order to form copolymers and/or graft copolymers. In the case of an acid (partial) hydrolysis of component (b), carbohydrate units can also be added on or in at the corresponding point.

The average molecular weight Mw of the copolymers to be utilized according to the present invention lies, for example, in the range above 1000, preferably about 5000, particularly preferably about 10,000, in particular above 15,000, advantageously between 18,000 and 70,000, extremely preferably between 20,000 and 65,000 g/mol. The molecular weight can be ascertained by gel permeation chromatography with reference to calibrated polyacrylic acid standards.

The production of graft copolymers is already known in the existing art, for example from U.S. Pat. No. 3,558,499 and DE 40 03 172 A1. The production of graft copolymers that are preferably to be utilized according to the present invention will be presented by way of example.

Production of graft copolymer A:

A mixture of 20 to 45 parts by weight of an acid complexing agent and approximately the same quantity of starch is dissolved in warm water, and then the same quantity by weight of acrylic acid and simultaneously 1 to 10 parts by weight of hydrogen peroxide in combination with a radical initiator, diluted as an aqueous solution, is slowly added with cooling and at constant temperature, as polymerization proceeds.

Once the reaction is complete, the product can optionally be diluted with water to the desired concentration and/or adjusted with suitable bases to a desired pH.

The textile care agent according to the present invention contains the copolymers that are to be utilized according to the present invention in an effective quantity, preferably greater than 0.05 wt %, particularly preferably from 0.1 to 10 wt %, in particular 1 to 5 wt %, in each case in terms of the agent as a whole.

In a further preferred embodiment of the present invention, the textile care agents additionally contain complexing agents. It has been found, surprisingly, that in particular organic, advantageously water-soluble complexing-agents can be incorporated particularly well into the textile care agents according to the present invention and, in particular together with the copolymers to be utilized according to the present invention, impart enhanced stability to the textile care agent, in particular to the liquid textile care agent. The complexing agents improve the stability of the agents and protect, for example, against the decomposition, catalyzed by heavy metals, of certain ingredients of washing-active formulations. Together with the copolymers to be utilized according to the present invention, they contribute to the inhibition of incrustations. In a preferred embodiment, the polymerization reaction to produce the copolymers is performed already in the presence of the complexing agents. Particularly preferred are, in particular, complexing agents that comprise acid groups and can additionally perform a pH-controlling function.

The group of complexing agents encompasses, for example, the alkali salts of nitrilotriacetic acid (NTA) and their derivatives, as well as alkali metal salts of anionic polyelectrolytes such as polymaleates and polysulfonates. Also suitable are citric acid, adipic acid, succinic acid, glutaric acid, malic acid, tartaric acid, maleic acid, fumaric acid, sugar acids, aminocarboxylic acids, and their derivatives, as well as mixtures thereof. Preferred compounds include, in particular, organophosphonates such as, for example, 1-hydroxyethane-1,1-diphosphonic acid (HEDP), amino tri(methylenephosphonic acid) (ATMP), diethylenetriamine penta(methylenephosphonic acid) (DTPMP or DETPMP), and 2-phosphonobutane-1,2,4-tricarboxylic acid (PBM-AM), which are usually used in the form of their ammonium or alkali metal salts.

Citric acid and/or its alkali metal salts, for example sodium citrate and/or potassium citrate, are particularly preferred in the context of the present invention.

In a preferred embodiment, the textile care agents contain complexing agents in a quantity up to 20 wt %, preferably from 0.01 to 15 wt %, particularly preferably from 0.1 to 10 and in particular from 0.3 to 5.0 wt % advantageously from 1.5 to 3 wt %, in each case in terms of the agent as a whole.

The textile care agents according to the present invention can be present both in solid form, for example as a powder, granulate, extrudate, pressed and/or melted shaped element, for example as a tablet, or preferably in liquid form, for example as a dispersion, suspension, emulsion, solution, microemulsion, gel, or paste.

In a preferred embodiment, the textile care agents according to the present invention additionally contain nonionic surfactants. The use of nonionic surfactants not only enhances the washing performance of the agents according to the present invention, but additionally assists the dispersion and homogeneous distribution of the copolymers to be utilized according to the present invention.

The nonionic surfactants used are preferably alkoxylated, advantageously ethoxylated and/or propoxylated, in particular primary, alcohols preferably having 8 to 18 carbon atoms and an average of 1 to 12 mol ethylene oxide (EO) and/or 1 to 10 mol propylene oxide (PO) per mol of alcohol. Particularly preferred are C₈-C₁₆ alcohol alkoxylates, advantageously ethoxylated and/or propoxylated C₁₀-C₁₅ alcohol alkoxylates, in particular C₁₂-C₁₄ alcohol alkoxylates, having a degree of ethoxylation between 2 and 10, preferably between 3 and 8, and/or a degree of propoxylation between 1 and 6, preferably between 1.5 and 5. The alcohol radical can preferably be linear or, particularly preferably, can be methyl-branched in the 2-position, or can contain in the mixture linear and methyl-branched radicals, such as those usually present in oxoalcohol radicals. Particularly preferred, however, are alcohol ethoxylates having linear radicals made up of alcohols of natural origin having 12 to 18 carbon atoms, e.g. from coconut, palm, tallow, or oleyl alcohol, and an average of 2 to 8 EO per mol of alcohol. The preferred ethoxylated alcohols include, for example C₁₂₋₁₄ alcohols having 3 EO or 4. EO, C₉₋₁₁ alcohols having 7 EO, C₁₃₋₁₅ alcohols having 3 EO, 5 EO, 7 EO, or 8 EO, C₁₂₋₁₈ alcohols having 3 EO, 5 EO, or 7 EO, and mixtures thereof, such as mixtures of C₁₂₋₁₄ alcohol having 3 EO and C₁₂₋₁₈ alcohol having 5 EO. The degrees of ethoxylation and propoxylation that are indicated represent statistical averages, which for a specific product may be a whole or fractional number. Preferred alcohol ethyoxylates and propoxylates exhibit a restricted homolog distribution (=narrow range ethoxylates/propoxylates, NRE/NRP). In addition to these nonionic surfactants, fatty alcohols having more than 12 EO can also be used.

Examples of these are tallow alcohol having 14 EO, 25 EO, 30 EO, or 40 EO.

Additionally suitable are alkoxylated amines, advantageously ethoxylated and/or propoxylated, in particular primary and secondary amines, having preferably 1 to 18 carbon atoms per alkyl chain and an average of 1 to 12 mol ethylene oxide (EO) and/or 1 to 10 mol propylene oxide (PO) per mol of amine.

Alkoxylated linear fatty amines and fatty alcohols have proven particularly advantageous, in particular for use in the nonaqueous formulations according to the present invention. In the case of the linear fatty alcohol alkoxylates and fatty amine alkoxylates, the terminal hydroxy groups of the fatty alcohol alkoxylates and fatty amine alkoxylates are etherified with C₁-C₂₀ alkyl groups, preferably methyl or ethyl groups.

It is also possible to use, as further nonionic surfactants, alkyl glycosides of the general formula RO(G)ₓ, for example as compounds in particular with anionic surfactants; in these, R denotes a primary aliphatic radical, straight-chain or methyl-branched, in particular methyl-branched in the 2-position, having 8 to 22, preferably 12 to 18 carbon atoms, and G is the symbol representing a glucose-type unit having 5 or 6 carbon atoms, preferably glucose. The degree of oligomerization x, which indicates the distribution of monoglycosides and oligoglycosides, is any number between 1 and 10; preferably x is between 1.2 and 1.4.

A further class of nonionic surfactants that can preferably be used, which are used either as a single nonionic surfactant or in combination with other nonionic surfactants, are alkoxylated, preferably ethoxylated or ethoxylated and propoxylated fatty acid alkyl esters, preferably having 1 to 4 carbon atoms in the alkyl chain, in particular fatty acid methyl esters, such as those described e.g. in Japanese Patent Application JP 58/217598 or those preferably produced according to the method described in International Patent Application WO-A-90/13533.

Further surfactants that are possible are so-called Gemini surfactants. These are understood in general as compounds that possess two hydrophilic groups and two hydrophobic groups per molecule. These groups are usually separated from one another by a so-called “spacer.” This spacer is usually a carbon chain which should be sufficiently long that the hydrophilic groups have enough spacing so that they can act independently of one another. Surfactants of this kind are generally characterized by an unusually low critical micelle concentration, and by the ability to greatly reduce the surface tension of the water. In exceptional cases, however, the expression “Gemini surfactants” is understood to mean not only dimeric but also trimeric surfactants.

Suitable Gemini surfactants are, for example, sulfated hydroxy mixed ethers according to German Patent Application DE-A43 21 022, or dimer alcohol bis- and trimeralcohol trisulfates and ethersulfates according to International Patent Application WO-A-96/23768. Linear dimeric and trimeric mixed ethers according to German Patent Application DE-A-195 13 391 are characterized in particular by their bi- and multifunctionality. For example, the aforesaid linear surfactants possess good wetting properties and are also low-foaming, so that they are particularly suitable for use in automatic washing or cleaning methods.

Germini polyhydroxy fatty acid amides or polypolyhydroxy fatty acid amides, such as those described in International Patent Applications WO-A-95/19953, WO-A-95/19954, and WO-A-95/19955, can, however also be used.

Additional suitable surfactants are polyhydroxy fatty acid amides of the following formula: 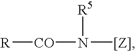
in which RCO denotes an aliphatic acyl radical having 6 to 22 carbon atoms; R⁵ hydrogen or an alkyl or hydroxyalkyl radical having 1 to 4 carbon atoms; and [Z] a linear or branched polyhydroxyalkyl radical having 3 to 10 carbon atoms and 3 to 10 hydroxyl groups. The polyhydroxy fatty acid amides are known substances that can usually be obtained by reductive amination of a reducing sugar using ammonia, an alkylamine, or an alkanolamine, and subsequent acylation with a fatty acid, a fatty acid alkyl ester, or a fatty acid chloride.

The group of the polyhydroxy fatty acid amides also includes compounds of the following formula: 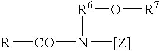
in which R denotes a linear or branched alkyl or alkylene radical having 7 to 12 carbon atoms; R⁶ a linear, branched, or cyclic alkyl radical or an aryl radical having 2 to 8 carbon atoms; and R⁷ a linear, branched, or cyclic alkyl radical or an aryl radical or an oxyalkyl radical having 1 to 8 carbon atoms, C₁₋₄ alkyl or phenyl radicals being preferred; and [Z] a linear polyhydroxyalkyl radical whose alkyl chain is substituted with at least two hydroxyl groups, or alkoxylated, preferably ethoxylated or propoxylated, derivatives of that radical.

[Z] is preferably obtained by reductive amination of a reduced sugar, for example glucose, fructose, maltose, lactose, galactose, mannose, or xylose. The N-alkoxy- or N-aryloxy-substituted compounds can then, for example according to the teaching of International Application WO-A-95/07331, be converted into the desired polyhydroxy fatty acid amides by reaction with fatty acid methyl esters in the presence of an alkoxide as catalyst.

It has proven advantageous for the textile care agent according to the present invention if nonionic surfactants selected from the group of the alkoxylated fatty alcohols and/or alkyl glycosides, in particular mixtures of alkoxylated fatty alcohols and alkyl glycosides, are used.

In a preferred embodiment, nonionic surfactants are present in the textile care agents according to the present invention in quantities of up to 35 wt %, preferably from 5 to 25 wt %, particularly preferably from 10 to 20 wt %, in each case in terms of the agent as a whole.

The textile care agents can furthermore, in a preferred embodiment, additionally contain anionic surfactants. The use of anionic surfactants distinctly enhances the dirt-loosening behavior of the agents according to the present invention during the washing process, without substantially impairing the effect of the copolymers to be utilized according to the present invention as fluff reduction components and creasing prevention components.

The anionic surfactants used are, for example, those of the sulfonate and sulfate types. Possible surfactants of the sulfonate type are, preferably, C₉₋₁₃ alkyl benzenesulfonates, olefin sulfonates, i.e. mixtures of alkene and hydroxyalkane sulfonates and disulfonates that are obtained, for example, from C₁₂₋₁₈ monoolefins having a terminal or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis or neutralization. Aslo suitable are the esters of α-sulfofatty acid (ester sulfonates), e.g. the α-sulfonated methyl esters of hydrogenated coconut, palm, or tallow acids.

Further suitable anionic surfactants are sulfonated fatty acid glycerol esters. “Fatty acid glycerol esters” are understood to be mono-, di-, and triesters, and mixtures thereof, such as those obtained during manufacture by esterification of a monoglycerol with 1 to 3 mol fatty acid, or by the transesterification of triglycerides with 0.3 to 2 mol glycerol. Preferred sulfonated fatty acid glycerol esters are the sulfonation products of saturated fatty acids having 6 to 22 carbon atoms, for example hexanoic acid, octanoic acid, decanoic acid, myristic acid, lauric acid, palmitic acid, stearic acid, or docosanoic acid.

Preferred as alk(en)yl sulfates are the alkaline and in particular sodium salts of the sulfuric acid semi-esters of the C₁₂-C₁₈ fatty alcohols, for example from cocoa butter alcohol, tallow alcohol, lauryl, myristyl, cetyl, or stearyl alcohol, or of the C₁₀-C₂₀ oxo alcohols, and those semi-esters of secondary alcohols having those chain lengths. Also preferred are alk(en)yl sulfates having the aforesaid chain length which contain a synthetic straight-chain alkyl radical, produced on a petrochemical basis, that possess degradation characteristics analogous to those of appropriate compounds based on fat-chemistry raw materials. Of interest in terms of washing technology are the C₁₂-C₁₆ alkyl sulfates and C₁₂-C₁₅ alkyl sulfates, and C₁₄-C₁₅ alkyl sulfates. 2,3-alkyl sulfates which are produced, for example, in accordance with U.S. Pat. Nos. 3,234,258 or 5,075,041 and may be obtained as commercial products of the Shell Oil Company under the name DAN®, are also suitable anionic surfactants.

Also suitable, and particularly preferred in the context of this invention, are the sulfuric acid monoesters of the straight-chain or branched C₇₋₂₁ alcohols ethoxylated with 1 to 6 mol ethylene oxide, such as 2-methyl branched C₉₋₁₁ alcohols having an average of 3. mol ethylene oxide (EO) or C₁₂₋₁₈ fatty alcohols having 1 to 4 EO, which are referred to as fatty alcohol ether sulfates.

Further suitable anionic surfactants are also the salts of alkylsulfosuccinic acid, which are also referred to as sulfosuccinates or sulfosuccinic acid esters, and which represent the monoesters and/or diesters of sulfosuccinic acid with alcohols, preferably fatty alcohols, and in particular ethoxylated fatty alcohols. Preferred sulfosuccinates contain C₈₋₁₈ fatty alcohol radicals or mixtures thereof. Particularly preferred sulfosuccinates contain a fatty alcohol radical that is derived from ethoxylated fatty alcohols which, considered of themselves, represent nonionic surfactants. Sulfosuccinates whose fatty alcohol radicals derive from ethoxylated fatty alcohols having a restricted homolog distribution are once again particularly preferred. It is likewise possible to use alk(en)ylsuccinic acid having preferably 8 to 18 carbon atoms in the alk(en)yl chain, or salts thereof.

Soaps are, in particular, possible as further anionic surfactants. Saturated fatty acid soaps, such as the salts of lauric acid, myristic acid, palmitic acid, stearic acid, hydrogenated erucic acid, and docosanoic acid, and soap mixtures derived in particular from natural fatty acids, e.g. cocoa butter, palm oil, or tallow acids, are suitable.

The anionic surfactants, including the soaps, can be present in the form of their sodium, potassium, or ammonium salts, and as soluble salts of organic bases, such as mono-, di-, or triethanolamine. The anionic surfactants are preferably present in the form of their sodium or potassium salts, in particular in the form of the sodium salts. For the nonaqueous liquid washing agent according to the present invention, however, the ammonium salts, in particular the salts of organic bases such as isopropylamine, are preferred.

A further class of anionic surfactants is the class of ethercarboxylic acids accessible by reacting fatty alcohol ethoxylates with sodium chloroacetate in the presence of basic catalysts. They have the general formula R¹⁰ O—(CH₂—CH₂—O)ₚ—CH₂—COOH, where R¹⁰=C₁-C₁₈ and p=0.1 to 20. Ethercarboxylic acids are insensitive to water hardness and exhibit outstanding surfactant properties. Their production and application are described, for example, in Seifen, Öle, Fette, Wachse 101, 37 (1975); 115, 235 (1989), and Tenside Deterg. 25, 308 (1988).

In a preferred embodiment, the textile cleaning agents according to the present invention contain anionic surfactants preferably selected from the group of the fatty alcohol sulfates and/or fatty alcohol ether sulfates and/or alkyl benzenesulfonates and/or soaps.

The anionic surfactant content can vary considerably depending on the intended application of the textile care agents according to the present invention. If the textile care agents are present as delicate fabric washing agents or post-treatment agents, for example as conditioners, the quantities are less than 10 wt %, preferably less than 5 wt %, and in particular less than 1 wt %, in each case in terms of the agent as a whole.

If the textile care agents are present as a solid or liquid complete washing agent, for example as a nonaqueous liquid washing agent, anionic surfactants can then be present in quantities up to 65 wt %, preferably in quantities up to 50 wt %, particularly preferably in quantities of 5 to 35 wt %, in each case in terms of the agent as a whole.

Furthermore, in a preferred embodiment, the textile care agents according to the present invention can additionally contain enzymes.

Enzymes assist washing processes in many ways, in particular in the elimination of contaminants that are difficult to bleach, for example protein stains. Problems often occur, however, with the incorporation of enzymes into washing agent formulations, in particular into liquid textile care agents, since incompatibilities with other washing agent constituents can occur which in turn can cause a loss of enzyme activity. It has been found, surprisingly, that with the use of the copolymers to be utilized according to the present invention, the stability of enzymes in a washing bath or textile care agent formulation, in particular in liquid textile care agent formulations, can be improved.

Suitable enzymes are, in particular, those of the hydrolase category, such as proteases, esterases, lipases and lipolytically active enzymes, amylases, cellulases and other glycosyl hydrolases, and mixtures of the aforesaid enzymes. All these hydrolases contribute, during washing, to the removal of stains such as protein-, grease-, or starch-containing stains, and graying. Cellulases and other glycosyl hydrolases can additionally contribute to color retention and to enhanced textile softness by removing pilling and microfibrils. Oxireductases can also be used for bleaching and to inhibit color transfer. Enzymatic ingredients obtained from bacterial strains or molds, such as Bacillus subtilis, Bacillus licheniformis, Streptomyceus griseus, and Humicola insolens, are particularly suitable. Proteases of the subtilisin type, and in particular proteases obtained from Bacillus lentus, are preferably used. Enzyme mixtures, for example of protease and amylase or protease and lipase or lipolytically active enzymes, or protease and cellulase, or of cellulase and lipase or lipolytically active enzymes, or of protease, amylase, and lipase or lipolytically active enzymes, or protease, lipase or lipolytically active enzymes, and cellulase, but in particular protease- and/or lipase-containing mixtures or mixtures with lipolytically active enzymes, are of particular interest in this context. Examples of such lipolytically active enzymes are the known cutinases. Peroxidases or oxidases have also proven suitable in certain cases. The suitable amylases include, in particular, α-amylases, isoamylases, pullulanases, and pectinases. Cellobiohydrolases, endoglucanases, and β-glucosidases, which are also called cellobiases, and mixtures thereof, are preferably used as cellulases. Because different types of cellulase have different CMCase and avicelase activities, the desired activities can be set by means of controlled mixtures of the cellulases.

The enzymes can be adsorbed onto carrier materials as shaped elements, or can be embedded in gel-coated fashion, in order to protect them from premature breakdown.

In a preferred embodiment, the textile care agents according to the present invention contain enzymes preferably selected from the group of the proteases and/or amylases and/or cellulases.

If the textile care agents according to the present invention are present as delicate fabric washing agents or post-treatment agents, for example as conditioners, in a preferred embodiment they can contain cellulase, preferably in a quantity from 0.005 to 2 wt %, particularly preferably from 0.01 to 1 wt %, in particular from 0.02 to 0.5 wt %, in each case in terms of the agent as a whole.

In a preferred embodiment, the textile care agents according to the present invention are present in liquid form and advantageously have a viscosity of 50 to 5000 mPas, particularly preferably from 50 to 3000 mPas, and in particular from 500 to 1500 mPas (measured at 20° C. in a rotary viscometer (Brookfield RV, spindle 2) at 20 rpm=revolutions per minute)).

In a preferred embodiment, preferred liquid textile care agents contain one or more solvents.

Solvents that can be used in the agents according to the present invention derive, for example, from the group of univalent or polyvalent alcohols, alkanolamines, or glycol ethers, provided they are miscible with water in the concentration range indicated. The solvents are preferably selected from ethanol, n- or i-propanol, butanols, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl, or propyl ether, butoxypropoxypropanol (BPP), dipropylene glycol monomethyl or ethyl ether, diisopropylene glycol monomethyl or ethyl ether, methoxy-, ethoxy-, or butoxytriglycol, 1-butoxyethoxy-2-propanol, 3-methyl-3-methyoxybutanol, propylene glycol t-butyl ether, and mixtures of these solvents.

Some glycol ethers are obtainable under the trade names Arcosolv® (Arco Chemical Co.) or Cellosolve®, Carbitol® or Propasol® (Union Carbide Corp.); these also include, for example, ButylCarbitol®, HexylCarbitol®, MethylCarbitol®, and Carbitol® itself, (2-(2-ethoxy)ethoxy)ethanol. One skilled in the art can easily select the glycol ether on the basis of its volatility, water solubility, weight percentage concentration in the agent as a whole, and the like. Pyrrolidone solvents, such as N-alkylpyrrolidones, for example N-methyl-2-pyrrolidone or N-C₈-C₁₂-alkylpyrrolidone, or 2-pyrrolidone, can also be used. It is also preferred to use alcohols. These include liquid polyethylene glycols having a low molecular weight, for example polyethylene glycols having a molecular weight of 200, 300, 400, or 600. Additional suitable alcohols are, for example, lower alcohols such as ethanol, propanol, isopropanol, and n-butanol, C₂-C₄ polyols such as diols or triols, for example ethylene glycol, propylene glycol, or glycerol, or mixtures thereof.

In a preferred embodiment, the textile care agents according to the present invention contain, if they are present in liquid form, up to 95 wt %, particularly preferably from 20 to 90 wt %, and in particular from 50 to 80 wt %, of one or more solvents, preferably water-soluble solvents, and in particular water.

In a preferred embodiment of the invention, the textile care agents additionally contain softener components, preferably cationic surfactants. The use of additional softener components has proven to be extremely advantageous in particular when the textile care agents according to the present invention are present as delicate fabric washing agents or textile post-treatment agents, for example as conditioners. The use of softener components has been successful in particular for the washing of sensitive textiles, for example silk, wool, or linen, that must be washedand ironed at low temperatures. The softener components, along with the copolymers to be utilized according to the present invention, additionally facilitate ironing of the textiles and reduce static charging of the textile materials.

Example of fabric-softening components are quaternary ammonium compounds, cationic polymers, and emulsifiers, such as those used in hair-care agents and also in textile brightening agents.

Suitable examples are quaternary ammonium compounds of formulas (I) and (II): 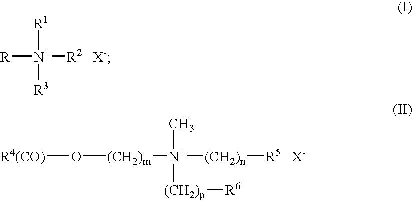
where in (I), R and R¹ denote an acyclic alkyl radical having 12 to 24 carbon atoms; R² denotes a saturated C₁-C₄ alkyl or hydroxyalkyl radical; and R³ either is identical to R, R¹, or R² or denotes an aromatic radical. X⁻ denotes either a halide, methosulfate, methophosphate, or phospate ion, and mixtures thereof. Examples of cationic compounds of formula (I) are didecyldimethylammonium chloride, ditallowdimethylammonium chloride, or dihexadecylammonium chloride.

Compounds of formula (II) are so-called esterquats. Esterquats are characterized by outstanding biodegradability and are particularly preferred in the context of the present invention. Here R⁴ denotes an aliphatic alkyl radical having 12 to 22 carbon atoms with 0, 1, 2, or 3 double bonds; R⁵ denotes H, OH, or O(CO)R⁷; and R⁶ denotes, independently of R⁵, H, OH, or O(CO)R⁸, R⁷ and R⁸ each denoting, independently of one another, an aliphatic alkyl radical having 12 to 22 carbon atoms with 0, 1, 2, or 3 double bonds. m, n, and p can each, independently of one another, have a value of 1, 2, or 3. X⁻ can be either a halide, methosulfate, methophosphate, or phosphate ion, as well as mixtures thereof. Compounds that contain the group O(CO)R⁷ for R⁵, and alkyl radicals having 16 to 18 carbon atoms for R⁴ and R⁷, are preferred. Compounds in which R⁶ additionally denotes OH are particularly preferred. Examples of compounds of formula (II) are methyl-N-(2-hydroxyethyl)-N,N-di(tallowacyloxyethyl)ammonium methosulfate, bis-(palmitoyl) ethylhydroxyethylmethylammonium methosulfate, or methyl-N,N-bis(acyloxyethyl)-N-(2-hydroxyethyl)ammonium methosulfate. If quaternized compounds of formula (II) having unsaturated alkyl chains are used, those acyl groups whose corresponding fatty acids have an iodine number of between 5 and 80, preferably between 10 and 60, and in particular between 15 and 45, and that have a cis/trans isomer ratio (in wt %) greater than 30:70, preferably greater than 50:50, and in particular greater than 70:30, are preferred. Commercial examples are the methyl hydroxyalkyldialkoyl oxyalkylammonium methosulfates marketed by Stepan under the trade name Stepantex®, or the products of Cognis known as Dehyquat®, or the products of Goldschmidt-Witco known as Rewoqua®. Further preferred compounds are the diesterquats of formula (III) that are obtainable under the name Rewoquat® W 222 LM or CR 3099, and provide not only softness but also stability and color protection

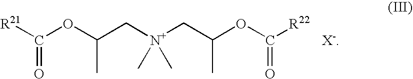

Here R²¹ and R²² each denote, independently of one another, an aliphatic radical having 12 to 22 carbon atoms with 0, 1, 2, or 3 double bonds.

In addition to the quaternary compounds described above, other known compounds, for example quaternary imidazolinium compounds of formula (IV), can also be used, 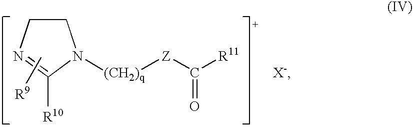
in which R⁹ denotes H or a saturated alkyl radical having 1 to 4 carbon atoms; R¹⁰ and R¹¹ each, independently of one another, denote an aliphatic, saturated, or unsaturated alkyl radical having 12 to 18 carbon atoms; R¹⁰ can alternatively also denote O(CO)R²⁰, where R²⁰ signifies an aliphatic, saturated, or unsaturated alkyl radical having 12 to 18 carbon atoms; Z signifies an NH group or oxygen; and X⁻ is an anion. q can assume integer values between 1 and 4.

Further suitable quaternary compounds are described by formula (V), 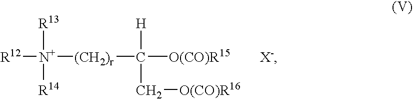
in which R¹², R¹³, and R¹⁴, independently of one another, denote a C₁₋₄ alkyl, alkylene, or hydroxyalkyl group; R¹⁵ and R¹⁶, each selected independently, represent a C₈₋₂₈ alkyl group; and r is a number between 0 and 5.

In addition to the compounds of formulas (I) and (II), short-chain water-soluble quaternary ammonium compounds can also be used, such as trihydroxyethylmethylammonium methosulfate or the alkyltrimethylammonium chlorides, dialkyldimethylammonium chlorides, and trialkylmethylammonium chlorides, e.g. cetyltrimethylammonium chloride, stearyltrimethylammonium chloride, distearyidimethylammonium chloride, lauryldimethylammonium chloride, lauryidimethylbenzylammonium chloride, and tricetylmethylammonium chloride.

Also suitable are protenated alkylamine compounds that have a softening effect, as well as unquaternized protonated precursors of the cationic emulsifiers.

The quaternized protein hydrolysates represent further cationic compounds usable according to the present invention.

Suitable cationic polymers include the polyquaternium polymers such as those described in the CTFA Cosmetic Ingredient Dictionary (The Cosmetic, Toiletry and Fragrance Association Inc., 1997), in particular the polyquaternium-6, polyquaternium-7, and polyquaternium-10 polymers also referred to as merquats (Ucare Polymer IR 400; Amerchol), polyquaternium-4 copolymers such as graft copolymers having a cellulose skeleton and quaternary ammonium groups that are bound via allyl dimethylammonium chloride, cationic cellulose derivatives such as cationic guar, such as guar hydroxypropyltriammonium chloride, and similar quaternized guar derivatives (e.g. Cosmedia Guar, manufacturer: Cognis GmbH), cationic quaternary sugar derivatives (cationic alkyl polyglucosides), e.g. the commercial product Glucquat® 100, according to CTFA nomenclature a “lauryl methyl gluceth-10 hydroxypropyl dimonium chloride,” copolymers of PVP and dimethyl aminomethacrylate, copolymers of vinylimidazole and vinylpyrrolidone, aminosilicone polymers and copolymers.

Also usable are polyquaternized polymers (e.g. Luviquat Care of BASF) and also chitin-based cationic biopolymers and their derivatives, for example the polymer obtained under the commercial name Chitosan® (manufacturer: Cognis).

Likewise suitable according to the present invention are cationic silicone oils, for example the commercially available products Q2-7224 (manufacturer: Dow Corning; a stabilized trimethylsilylamodimethicone), Dow Corning 929 Emulsion (containing a hydroxylamino-modified silicone that is also referred to as amodimethicone), SM-2059 (manufacturer: General Electric),. SLM-55067 (manufacturer: Wacker), Abil®-Quat 3270 and 3272 (manufacturer: Goldschmidt-Rewo; diquaternary polydimethylsiloxanes, quaternium-80), and Siliconquat Rewoquat® SQ 1 (Tegopren° 6922, manufacturer: Goldschmidt-Rewo).

Also usable are compounds of formula (VI), 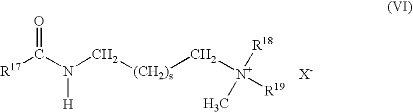
which can be alkylamidoamines in their unquaternized or, as depicted, quaternized form. R¹⁷ can be an aliphatic alkyl radical having 12 to 22 carbon atoms with 0, 1, 2, or 3 double bonds. s can assume values between 0 and 5. R¹⁸ and R¹⁹ each denote, independently of one another, H, C₁₋₄ alkyl, or hydroxyalkyl. Preferred compounds are fatty acid aminoamines such as the stearylaminopropyidimethylamine obtained under the name Tego Amid® S18, or the 3-tallowamidopropyl trimethylammonium methosulfate obtainable under the name Stepantex® X 9124, which are distinguished not only by a good conditioning action but also by a color transfer-inhibiting effect, and especially by their good biodegradability. Particularly preferred are alkylated quaternary ammonium compounds in which at least one alkyl chain is interrupted by an ester group and/or amido group, in particular N-methyl-N(2-hydroxyethyl)-N,N-(ditallowacyloxyethyl)ammonium methosulfate and/or N-methyl-N(2-hydroxyethyl)-N,N-(dipalmitoylethyl)ammonium methosulfate.

Suitable as nonionic softeners are, especially, polyoxyalkylene glycerol alkanoates as described in British Patent GB 2,202,244, polybutylenes as described in British Patent GB 2,199,855, long-chain fatty acids as described in EP 13 780, ethoxylated fatty acid ethanolamides as described in EP 43 547, alkylpolyglycosides, in particular sorbitan mono-, di-, and triesters, as described in EP 698 140, and fatty acid esters of polycarboxylic acids as described in German Patent DE 28 22 891.

In a preferred embodiment, the delicate fabric washing agents according to the present invention contain cationic surfactants, preferably alkylated quaternary ammonium compounds in which at least one alkyl chain is interrupted by an ester group and/or amido group, in particular N-methyl-N(2-hydroxyethyl)-N,N-(ditallowacyloxyethyl)ammonium methosulfate or N-methyl-N(2-hydroxyethyl)-N,N-(dipalmitoylethyl)ammonium methosulfate.

In a further preferred embodiment, the textile care agents according to the present invention contain softener components in a quantity of up to 35 wt %, preferably from 0.1 to 25 wt %, particularly preferably from 0.5 to 15 wt %, and in particular from 1 to 10 wt %, in each case in terms of the agent as a whole.

In a particularly preferred embodiment of the invention the textile care agents according to the present invention are present as delicate fabric washing agents or conditioners containing softeners, preferably cationic softeners, particularly preferably esterquats.

In addition to the aforementioned components, the textile care agents according to the present invention can contain luster agents. Luster agents impart an additional luster to the textiles and are therefore preferably used in the delicate fabric washing agents according to the present invention.

Suitable luster agents are, for example: alkylene glycol esters; fatty acid alkanolamides; partial glycerides; esters of polyvalent, optionally hydroxy-substituted carboxylic acids with fatty alcohols having 6 to 22 carbon atoms; fatty substances, for example fatty alcohols, fatty ketones, fatty aldehydes, fatty ethers, and fatty carbonates, that have a total of at least 24 carbon atoms; ring opening products of olefin epoxides having 12 to 22 carbon atoms with fatty alcohols having 12 to 22 carbon atoms, fatty acids and/or polyols having 2 to 15 carbon atoms and 2 to 10 hydroxyl groups, and mixtures thereof.

The textile care agents according to the present invention can also additionally contain thickeners. The use of thickeners has proven particularly advantageous in textile care agents according to the present invention that are present as liquid washing agents. The use of thickening agents has been successful in particular in the case of liquid washing agents in gel form, in order to increase consumer acceptance. The thickened consistency of the agent simplifies application of the agents directly onto the stains to be treated. This suppresses dripping, which is common with less-viscous agents.

Polymers derived from nature that are used as thickening agents are, for example, agar-agar, carrageenan, tragacanth, gum arabic, alginates, pectins, polyoses, guar flour, locust bean gum, starch, dextrins, gelatins, and casein.

Modified natural substances derive principally from the group of the modified starches and celluloses; carboxymethylcellulose and cellulose ether, hydroxyethyl- and propylcellulose, and seed flour ethers may be cited as examples.

A large group of thickening agents that are extensively used in a wide variety of application areas are the completely synthetic polymers such as polyacryl and polymethyacryl compounds, vinyl polymers, polycarboxylic acids, polyethers, polyimines, polyamides, and polyurethanes.

Thickening agents from the aforementioned substance classes are widely available commercially and are obtainable, for example, under the trade names Acusol® 820 (methacrylic acid(stearyl alcohol-20-EO)ester/acrylic acid copolymer, 30% in water; Rohm & Haas), Dapral® GT-282-S (alkylpolyglycol ether, Akzo), Deuterol® polymer-11 (dicarboxylic acid copolymer, Schöner GmbH), Deuteron® XG (anionic heteropolysaccharide based on β-D-glucose, D-mannose, D-glucuronic acid; Schöner GmbH), Deuteron® XN (nonionogenic polysaccharide, Schöner GmbH), Dicrylan® Thickener O (ethylene oxide adduct, 50% in water/isopropanol; Pfersse Chemie) EMA® 81 and EMA® 91 (ethylene/maleic acid anhydride copolymer, Monsanto), QR-1001 thickener (polyurethane emulsion, 19-21% in water/diglycol ether; Rohm & Haas), Mirox® AM (anionic acrylic acid/acrylic acid ester copolymer dispersion, 25% in water; Stockhausen), SER-AD-FX 1100 (hydrophobic urethane polymer, Servo Delden), Shellflo® S (high-molecular-weight polysaccharide, stabilized with formaldehyde; Shell), and Shellflo® XA (xanthan biopolymer, stabilized with formaldehyde; Shell).

A polymeric polysaccharide thickening agent that is preferred for use is xanthan, a microbial anionic heteropolysaccharide that is produced by Xanthomonas campestris and some other species under aerobic conditions and has a molar weight of 2 to 15 million g/mol. Xanthan is made up of a chain comprising β-1,4-bound glucose (cellulose), with graft chains. The structure of the subgroups comprises glucose, mannose, glucuronic acid, acetate, and pyruvate, the number of pyruvate units determining the viscosity of the xanthan.

Because they are largely stable with respect to acid and oxidation, it is particularly advantageous to use xanthans and modified xanthans.

Xanthan can be described by the following formula:

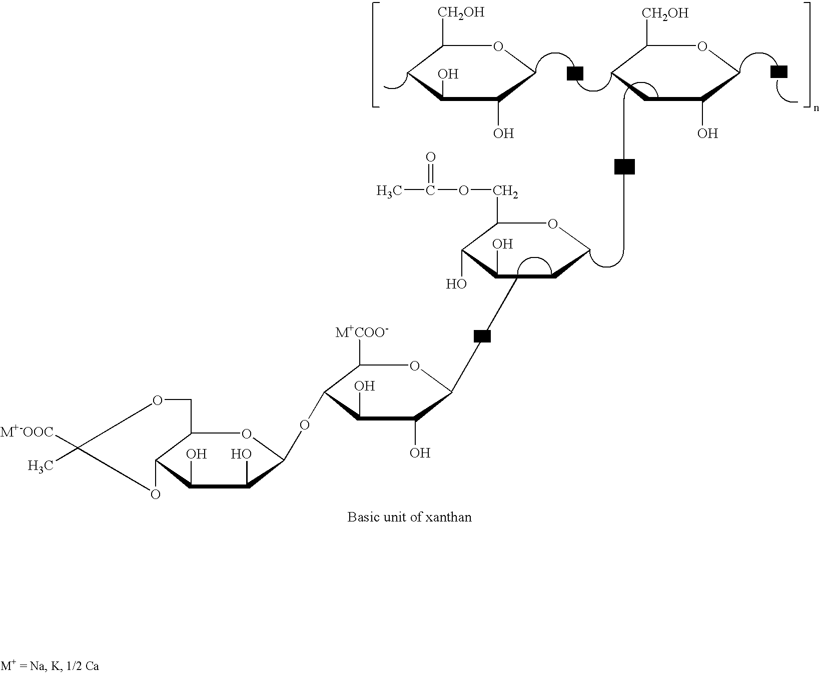

In a preferred embodiment, the textile care agents according to the present invention additionally contain thickeners, preferably in quantities of up to 10 wt %, particularly preferably up to 5 wt %, in particular from 0.1 to 1 wt %, in each case in terms of the agent as a whole.

The textile care agents according to the present invention can additionally contain odor absorbers and/or color transfer inhibitors. The use of color transfer inhibitors has proven particularly successful for the textile care agents according to the present invention that are present as delicate fabric washing agents, post-treatment agents, and liquid washing agents. The use of odor absorbers has proven very helpful in order to deodorize unpleasant-smelling formulation constituents, for example amine-containing components, but also for long-lasting deodorization of the washed textiles.

In a preferred embodiment, the textile care agents according to the present invention optionally contain from 0.1 wt % to 2 wt %, preferably from 0.2 wt % to 1 wt %, of a color transfer inhibitor, which in a preferred embodiment of the invention is a polymer of vinylpyrrolidone, vinylimidazole, vinylpyridine-N-oxide, or a copolymer thereof. Also usable are the polyvinylpyrrolidones with molecular weights from 15,000 to 50,000 known from European Patent Application EP 0 262 897, as well as the polyvinylpyrrolidones with molecular weights of more than 1,000,000, in particular from 1,500,000 to 4,000,000,known from International Patent Application WO 95/06098, the N-vinylimidazole/N-vinylpyrrolidone copolymers known from German Patent Applications DE 28 14 287 or DE 38 03 630 or International Patent Applications WO 94/10281, WO 94/26796, WO 95/03388, and WO 95/03382, the polyvinyloxazolidones known from German Patent Application DE 28 14 329, the copolymers based on vinyl monomers and carboxylic acid amides known from European Patent Application EP 610 846, the pyrrolidone-group-containing polyesters and polyamides known from International Patent Application WO 95/09194, the grafted polyamidoamines and polyethylenimines known from International Patent Application WO 94/29422, the polymers having amide groups made up of secondary amines known from German Patent Application DE 43 28 254, the polyamine-N-oxide polymers known from International Patent Application WO 94/02579 or European Patent Application EP 0 135 217, the polyvinyl alcohols known from European Patent Application EP 0 584 738, and the copolymers based on acrylamidoalkenyl sulfonic acids known from European Patent Application EP 0 584 709. It is also possible, however, to use enzymatic systems encompassing a peroxidase and hydrogen peroxide or a substance that yields hydrogen peroxide in water, such as known e.g. from International Patent Applications WO 92/18687 and WO 91/05839. The addition of a mediator compound for peroxidase, for example an acetosyringon known from International Patent Application WO 96/10079, a phenol derivative known from International Patent Application WO 96/12845, or a phenothiazine or phenoxazine known from International Patent Application WO 96/12846, is preferred in this case, in which context aforementioned polymeric color transfer-inhibiting ingredients can also be additionally used. Polyvinylpyrrolidone preferably has, for use in agents according to the present invention, an average molar weight in the range from 10,000 to 60,000, in particular in the range from 25,000 to 50,000. Among the copolymers, those of vinylpyrrolidone and vinylimidazole at a molar ratio of 5:1 to 1:1, with an average molar weight in the range from 5000 to 50,000, in particular from 10,000 to 20,000, are preferred.

Preferred deodorizing substances for purposes of the invention are one or more metal salts of an unbranched or branched, unsaturated or saturated, singly or multiply hydroxylated fatty acid having at least 16 carbon atoms, and/or a resin acid with the exception of the alkali metal salts, and any mixtures thereof.

A particularly preferred unbranched or branched, unsaturated or saturated, singly or multiply hydroxylated fatty acid having at least 16 carbon atoms is ricinoleic acid. A particularly preferred resin acid is abietic acid.

Preferred metals are the transition metals and the lanthanoids, in particular the transition metals of groups VIIIa, Ib, and IIb of the periodic table, such as lanthanum, cerium, and neodymium, particularly preferably cobalt, nickel, copper, and zinc, particularly preferably zinc. The cobalt, nickel and copper salts and the zinc salts have similar effectiveness, but the zinc salts are nevertheless preferable for toxicological reasons.

One or more metal salts of ricinoleic acid and/or abietic acid, preferably zinc ricinoleate and/or zinc abietate, in particular zinc ricinoleate, are to be utilized advantageously and therefore particularly preferably as deodorizing substances.

Likewise suitable as deodorizing substances for purposes of the invention are cyclodextrins as well as any mixtures of the aforementioned metal salts with cyclodextrins, preferably at a weight ratio of 1:10 to 10:1, particularly preferably of 1:5 to 5:1, and in particular of 1:3 to 3:1. The term “cyclodextrin” encompasses all known cyclodextrins, i.e. both unsubstituted cyclodextrins having from 6 to 12 glucose units, in particular alpha-, beta- and gamma-cyclodextrins and mixtures thereof, and/or derivatives thereof and/or mixtures thereof.

The textile care agents according to the present invention can additionally contain further surfactants, for example amphoteric surfactants.

The amphoteric surfactants (zwitterionic surfactants) that can be used according to the present invention include betaines, amine oxides, alkylamidoalkylamines, alkyl-substituted amino acids, acylated amino acids, or biosurfactants, of which the betaines are particularly preferred in the context of the teaching of the present invention.

Suitable betaines are the alkyl betaines, alkylamidobetaines, imidazolinium betaines, sulfobetaines (INCI sultaines), and the phosphobetaines, and preferably conform to formula I:
R¹—[CO—X—(CH₂)ₙ]ₓ—N⁺(R²)(R³)—(CH₂)ₘ—[CH(OH)—CH₂]_{y}—Y⁻ (I)
where R¹ is a saturated or unsaturated C₆₋₂₂ alkyl radical, preferably C₈₋₁₈ alkyl radical, in particular a saturated C₁₀₋₁₆ alkyl radical, for example a saturated C₁₂₋₁₄ alkyl radical,
X is NH, NR⁴ having the C₁₋₄ alkyl radical R⁴, O, or S,
n is a number from 1 to 10, preferably from 2 to 5, in particular 3,
x is O or 1, preferably 1,
R², R are, independently of one another, a C₁₋₄ alkyl radical, optionally hydroxy-substituted, for example a hydroxyethyl radical, but in particular a methyl radical,
m is a number from 1 to 4, in particular 1, 2, or 3,
y is 0 or 1, and
Y is COO, SO₃, OPO(OR⁵)O or P(O)OR⁵)O, R⁵ being a hydrogen atom H or a C₁₋₄ alkyl radical.

The alkyl betaines and alkylamidobetaines, betaines of formula I having a carboxylate group (Y⁻═COO⁻), are also called carbobetaines.

Preferred amphoteric surfactants are the alkyl betaines of formula (Ia), the alkylamidobetaines of formula (Ib), the sulfobetaines of formula (Ic), and the amidosulfobetaines of formula (Id):
R¹—N⁺—(CH₃)₂—CH₂COO (Ia)
R¹—CO—NH—(CH₂)₃—N⁺(CH₃)₂—CH₂COO⁻ (Ib)
R¹—N⁺(CH₃)₂—CH₂CH(OH)CH₂SO₃⁻ (Ic)
R¹—CO—NH—(CH₂)₃—N⁺(CH₃)₂—CH₂CH(OH)CH₂SO₃⁻ (Id)
in which R¹ has the same meaning as in formula 1.

Particularly preferred amphoteric surfactants are the carbobetaines, in particular the carbobetaines of formulas (Ia) and (Ib), extremely preferably the alkylamidobetaines of formula (Ib).

Examples of suitable betaines and sulfobetaines are the following compounds, named in accordance with INCI: almondamidopropyl betaine, apricotamidopropyl betaine, avocadamindopropyl betaine, babassuamidopropyl betaine, behenamidopropyl betaine, behenyl betaine, betaine, canolamidopropyl betaine, capril/capramidopropyl betaine, carnitine, cetyl betaine, cocamidoethyl betaine, cocamidopropyl betaine, cocamidopropyl hydroxysultaine, coco-betaine, coco-hydroxysultaine, coco/oleamidopropyl betaine, coco-sultaine, decyl betaine, dihydroxyethyl oleyl glycinate, dihydroxyethyl soy glycinate, dihydroxyethyl stearyl glycinate, dihydroxyethyl tallow glycinate, dimethicone propyl PG-betaine, erucamidopropyl hydroxysultaine, hydrogenated tallow betaine, isostearamidopropyl betaine, lauramidopropyl betaine, lauryl betaine, lauryl hydroxysultaine, lauryl sultaine, milkamidopropyl betaine, minkamidopropyl betaine, myristamidopropyl betaine, myristyl betaine, oleamidopropyl betaine, oleamidopropyl hydroxysultaine, oleyl betaine, olivamidopropyl betaine, palmamidopropyl betaine, palmitamidopropyl betaine, palmitoyl carnitine, palm kernelamidopropyl betaine, polytetrafluoroethylene acetoxypropyl betaine, ricinoleamidopropyl betaine, sesamidopropyl betaine, soyamidopropyl betaine, stearamidopropyl betaine, stearyl betaine, tallowamidopropyl betaine, tallowamidopropyl hydroxysultaine, tallow betaine, tallow dihydroxyethyl betaine, undecylenamidopropyl betaine, and wheat germamidopropyl betaine.

The amine oxides suitable according to the present invention include alkylamine oxides, in particular alkyldimethylamine oxides, alkylamidoamine oxides, and alkoxyalkylamine oxides. Preferred amine oxides conform to formula II:
R⁶R⁷R⁸N⁺—O⁻ (II)
R⁶[CO—NH—(CH₂)_{w}]_{z}—N⁺(R⁷)(R⁸)—O (II)
in which R⁶ is a saturated or unsaturated C₆₋₂₂ alkyl radical, preferably a C₈₋₁₈ alkyl radical, in particular a saturated C₁₀₋₁₆ alkyl radical, for example a saturated C₁₂₋₁₄ alkyl radical, that is incorporated into the alkylamidoamine oxides via a carbonylamidoalkylene group —CO—NH—(CH₂)_{z}— and into the alkoxyalkylamine oxides via an oxaalkylene group —O—(CH₂)_{z}— at the nitrogen atom N, z being in each case a number from 1 to 10, preferably from 2 to 5, in particular 3,
R⁷, R⁸ are, independently of one another, a C₁₋₄ alkyl radical, optionally hydroxy-substituted, for example a hydroxyethyl radical, in particular a methyl radical.

Examples of suitable amine oxides are the following compounds, named in accordance with INCI: almondamidopropylamine oxide, babassuamidopropylamine oxide, behenamine oxide, cocamidopropyl amine oxide, cocamidopropylamine oxide, cocamine oxide, coco-morpholine oxide, decylamine oxide, decyltetradecylamine oxide, diaminopyrimidine oxide, dihydroxyethyl C8-10 alkoxypropylamine oxide, dihydroxyethyl C9-1 1 alkoxypropylamine oxide, dihydroxyethyl C12-15 alkoxypropylamine oxide, dihydroxyethyl cocamine oxide, dihydroxyethyl lauramine oxide, dihydroxyethyl stearamine oxide, dihydroxyethyl tallowamine oxide, hydrogenated palm kernel amine oxide, hydrogenated tallowamine oxide, hydroxyethyl hydroxypropyl C12-15 alkoxypropylamine oxide, isostearamidopropylamine oxide, isostearamidopropyl morpholine oxide, lauramidopropylamine oxide, lauramine oxide, methyl morpholine oxide, milkamidopropyl amine oxide, minkamidopropylamine oxide, myristamidoproplyamine oxide, myristamine oxide, myristyl/cetyl amine oxide, oleamidopropylamine oxide, oleamine oxide, olivamidopropylamine oxide, palmitamidopropylamine oxide, palmitamine oxide, PEG-3 lauramine oxide, potassium dihydroxyethyl cocamine oxide phosphate, potassium triphosphonomethylamine oxide, sesamidopropylamine oxide, soyamidopropylamine oxide, stearamidopropylamine oxide, stearamine oxide, tallowamidopropylamine oxide, tallowamine oxide, undecylenamidopropylamine oxide, and wheat germamidopropylamine oxide.

The alkylamido alkylamines (per INCI) are amphoteric surfactants of formula (III):
R⁹—CO—NR¹⁰—(CH₂)ᵢ—N(R¹¹)—(CH₂CH₂O)ⱼ—(CH₂)ₖ—[CH(OH)]ₗ—CH₂-Z-OM (III)
in which R⁹ is a saturated or unsaturated C₆₋₂₂ alkyl radical, preferably a C₈₋₁₈ alkyl radical, in particular a saturated C₁₀₋₁₆ alkyl radical, for example a saturated C₁₂₋₁₄ alkyl radical,
R¹⁰ is a hydrogen atom H or a C₁₋₄ alkyl radical, preferably H,
i is a number from 1 to 10, preferably from 2 to 5, in particular 2 or 3,
R¹¹ is a hydrogen atom H or CH₂COOM (see below for M),
j is a number from 1 to 4, preferably 1 or 2, in particular 1,
k is a number from 0 to 4, preferably 0 or 1,
l is 0 or 1, such that k=1 when l=1,
Z is CO, SO₂, OPO(OR¹²), or P(O)(OR¹²), where R¹² is a C₁₋₄ alkyl radical or M (see below), and
M is a hydrogen, an alkali metal, an alkaline-earth metal, or a protonated alkanolamine, e.g. a protonated mono-, di-, or triethanolamine.

Preferred representative conform to formulas IIIa to IIId:
R⁹—CO—NH—(CH₂)₂—N(R¹¹)—CH₂CH₂O—CH₂—COOM (IIIa)
R⁹—CO—NH—(CH₂)₂—N(R¹¹)—CH₂CH₂O—CH₂CH₂—COOM (IIIb)
R⁹—CO—NH—(CH₂)₂—N(R¹¹)—CH₂CH₂O—CH₂CH(OH)CH₂—SO₃M (IIIc)
R⁹—CO—NH—(CH₂)₂—N(R¹¹)—CH₂CH₂O—CH₂CH(OH)CH₂—OPO₃HM (IIId)
in which R¹¹ and M have the same meanings as in formula (III).

Examples of alkylamido alkylamines are the following compounds, named in accordance with INCI: cocamphodipropionic acid, cocobetainamido amphoproprionate, DEA-cocoamphodipropionate, disodium caproamphodiacetate, disodium caproamphodipropionate, disodium caprylamphodiacetate, disodium capryloamphodipropionate, disodium cocoamphocarboxyethylhydroxypropylsulfonate, disodium cocoamphodiacetate, disodium cocamphodipropionate, disodium isostearoamphodiacetate, disodium isostearoamphodipropionate, disodium laureth-5 carboxyamphodiacetate, disodium lauroamphodiacetate, disodium lauroamphodipropionate, disodium oleoamphodipropionate, disodium PPG-2-isodeceth-7 carboxyamphodiacetate, disodium stearoamphodiacetate, disodium tallowamphodiacetate, disodium wheatgermamphodiacetate, lauroamphodipropionic acid, quaternium-85, sodium caproamphoacetate, sodium caproamphohydroxypropylsulfonate, sodium caproamphopropionate, sodium capryloamphoacetate, sodium capryloamphohydroxypropylsulfonate, sodium capryloamphopropionate, sodium cocoamphoacetate, sodium cocoamphohydroxypropylsulfonate, sodium cocoamphopropionate, sodium cornamphopropionate, sodium isostearoamphoacetate, sodium isostearoamphopropionate, sodium lauroamphoacetate, sodium lauroamphohydroxypropylsulfonate, sodium lauroampho PG-acetate phosphate, sodium lauroamphopropionate, sodium myristoamphoacetate, sodium oleoamphoacetate, sodium oleoamphohydroxypropylsulfonate, sodium ricinoleoamphoacetate, sodium stearoamphoacetate, sodium stearoamphohydroxypropylsulfonate, sodium stearoamphopropionate, sodium tallampropropionate, sodium tallowamphoacetate, sodium undecylenoamphoacetate, sodium undecylenoamphopropionate, sodium wheat germamphoacetate, and trisodium lauroampho PG-acetate chloride phosphate.

Alkyl-substituted amino acids (per INCI) preferred according to the present invention are monoalkyl-substituted amino acids conforming to formula (IV):
R¹³—NH—CH(R¹⁴)—(CH₂)ᵤ—COOM′ (IV)
in which R¹³is a saturated or unsaturated C₆₋₂₂ alkyl radical, preferably a C₈₋₁₈ alkyl radical, in particular a saturated C₁₀₋₁₆ alkyl radical, for example a saturated C₁₂₋₁₄ alkyl radical,
R¹⁴ is a hydrogen atom H or a C₁₋₄ alkyl radical, preferably H,
u is a number from 0 to 4, preferably 0 or 1, in particular 1, and
M′ is a hydrogen, an alkali metal, an alkaline-earth metal, or a protonated alkanolamine, e.g. a protonated mono-, di-, or triethanolamine,
alkyl-substituted imino acids according to formula (V):
   R¹⁵—N—[(CH₂)ᵥ—COOM″]₂ (V)
   in which R¹⁵ is a saturated or unsaturated C₆₋₂₂ alkyl radical, preferably a C₈₋₁₈ alkyl radical, in particular a saturated C₁₀₋₁₆ alkyl radical, for example a saturated C₁₂₋₁₄ alkyl radical,
v is a number from 1 to 5, preferably 2 or 3, in particular 2, and
M″ is a hydrogen, an alkali metal, an alkaline-earth metal, or a protonated alkanolamine, e.g. a protonated mono-, di-, or triethanolamine, where M″ can have the same or two different meanings in the two carboxy groups, e.g. can be hydrogen and sodium or sodium in both cases, and mono- or dialkyl-substituted natural amino acids according to formula (VI):
   R¹⁶—N(R¹⁷)—CH(R¹⁸)—COOM′″ (VI)
   in which R¹⁶ is a saturated or unsaturated C₆₋₂₂ alkyl radical, preferably a C₈₋₁₈ alkyl radical, in particular a saturated C₁₀₋₁₆ alkyl radical, for example a saturated C₁₂₋₁₄ alkyl radical,
R¹⁷ is a hydrogen atom or a C₁₋₄ alkyl radical, optionally hydroxy- or amino-substituted, e.g. a methyl, ethyl, hydroxyethyl, or aminopropyl radical,
R¹⁸ is the radical of one of the twenty natural α-amino acids H₂NCH(R¹⁸)COOH, and
M′″ is a hydrogen, an alkali metal, an alkaline-earth metal, or a protonated alkanolamine, e.g. a protonated mono-, di-, or triethanolamine.

Particularly preferred alkyl-substituted amino acids are the aminopropionates according to formula (IVa):
R¹³—NH—CH₂CH₂—COOM′ (IVa)
in which R¹³ and M′ have the same meanings as in formula (IV).

Examples of alkyl-substituted amino acids are the following compounds, named in accordance with INCI: aminopropyl laurylglutamine, cocaminobutyric acid, cocaminopropionic acid, DEA-lauraminopropionate, disodium cocaminopropyl iminodiacetate, disodium dicarboxyethyl cocopropylenediamine, disodium lauriminodipropionate, disodium steariminodipropionate, disodium tallowiminodipropionate, lauraminopropionic acid, lauryl aminopropylclycine, lauryl diethylenediaminoglycine, myristaminopropionic acid, sodium C12-15 alkoxypropyl iminodipropionate, sodium cocaminopropionate, sodium lauraminopropionate, sodium lauriminidipropionate, sodium lauriminodipropionate, sodium lauroyl methylaminopropionate, TEA-lauraminopropionate, and TEA-myristaminopropionate.

Acylated amino acids are amino acids, in particular the twenty natural α-amino acids, that carry on the amino nitrogen atom the acyl radical R¹⁹CO of a saturated or unsaturated fatty acid R¹⁹COOH, where R¹⁹ is a saturated or unsaturated C₆₋₂₂ alkyl radical, preferably a C₈₋₁₈ alkyl radical, in particular a saturated C₁₀₋₁₆ alkyl radical, for example a saturated C₁₂₋₁₄ alkyl radical. The acylated amino acids can also be used as the alkali metal salt, alkaline-earth metal salt, or alkanolammonium salt, e.g. mono-, di-, or triethanolammonium salt. Examples of acylated amino acids are the acyl derivatives grouped together according to INCI as “amino acids,” e.g. sodium cocoyl glutamate, lauroyl glutamic acid, capryloyl glycine, or myristoyl methylalanine.

In a preferred embodiment, the total surfactant content of the textile care agents according to the present invention, without the quantity of fatty acid soap, is less than 55 wt %, preferably less than 50 wt %, particularly preferably between 38 and 48 wt %, in each case in terms of the agent as a whole.

The textile care agents according to the present invention can additionally contain further washing agent additives, for example from the group of detergency builders, bleaching agents, bleach activators, electrolytes, pH adjusting agents, fragrances, perfume carriers, fluorescence agents, colorants, foam inhibitors, graying inhibitors, crease-prevention agents, antimicrobial ingredients, germicides, fungicides, antioxidants, antistatic agents, ironing adjuvants, UV absorbers, optical brighteners, antiredeposition agents, viscosity regulators, shrinkage preventers, corrosion inhibitors, preservatives, proofing and impregnation agents.

The agents according to the present invention can contain detergency builders.

All detergency builders usually used in washing and cleaning agents can be introduced into the agents according to the present invention, i.e. in particular zeolites, silicates, carbonates, organic cobuilders and even (where no environmental prejudices against their use exist) phosphates.

Suitable crystalline, sheet-form sodium silicates possess the general formula NaMSiₓO₂ₓ₊₁.H₂O, where M denotes sodium or hydrogen, x a number from 1.9 to 4, and y is a number from 0 to 20, and preferred values for x are 2, 3, or 4. Crystalline sheet silicates of this kind are described, for example, in European Patent Application EP-A-0 164 514. Preferred crystalline sheet silicates of the formula indicated above are those in which M denotes sodium and x assumes the value 2 or 3. Both β- and δ-sodium disilicates Na₂Si₂O₅.yH₂O are particularly preferred; β-sodium disilicate can be obtained, for example, according to the method described in International Patent Application WO-A-91/08171.

Also usable are amorphous sodium silicates having a Na₂O:SiO₂ modulus of 1:2 to 1:3.3, preferably 1:2 to 1:2.8, and in particular 1:2 to 1:2.6, which are dissolution-delayed and exhibit secondary washing properties. Dissolution delay as compared with conventional amorphous sodium silicates can have been brought about in various ways, for example by surface treatment, compounding, compacting/densification, or overdrying. In the context of this invention, the term “amorphous” is also understood to mean “X-amorphous.” In other words, in X-ray diffraction experiments the silicates yield not the sharp X-ray reflections that are typical of crystalline substances, but instead at most one or more maxima in the scattered X radiation, having a width of several degree units of the diffraction angle. Particularly good builder properties can, however, very easily be obtained even if the silicate particles yield blurred or even sharp diffraction maxima in electron beam diffraction experiments. This may be interpreted to mean that the products have microcrystalline regions 10 to several hundred nm in size, values of up to a maximum of 50 nm, and in particular a maximum of 20 nm, being preferred. So-called X-amorphous silicates of this kind, which also exhibit a dissolution delay as compared with conventional water glasses, are described, for example, in German Patent Application DE-A44 00 024. Densified/compacted amorphous silicates, compounded amorphous silicates, and overdried X-amorphous silicates are particularly preferred.

The finely crystalline synthetic zeolite containing bound water is preferably zeolite A and/or zeolite P. Zeolite MAP® (commercial product of the Crosfield Co.) is particularly preferred as zeolite P. Also suitable, however, are zeolite X as well as mixtures of A, X, and/or P. Also commercially available and preferred for use in the context of the present invention is, for example, a co-crystal of zeolite X and zeolite A (approx. 80 wt % zeolite X) that is marketed by CONDEA Augusta S.p.A. under the trade name VEGOBOND AX® and can be described by the formula
nNa₂O.(1-n)K₂O.Al₂O₃.(2-2.5)SiO₂.(3.5-5.5)H₂O.

Suitable zeolites exhibit an average particle size of less than 10 μm (volume distribution; measurement method: Coulter Counter), and preferably contain from 18 to 22 wt %, in particular from 20 to 22 wt %, of bound water. The zeolites can also be used as overdried zeolites with low water contents, and are then suitable, because of their hygroscopic nature, for the removal of undesired trace amounts of free water.

Use of the commonly known phosphates as builder substances is also possible, of course, provided such use is not to be avoided for environmental reasons. The sodium salts of the orthophosphates, pyrophosphates, and in particular the tripolyphosphates are particularly suitable.

Polymeric polycarboxylates are furthermore suitable as builders; these are, for example, the alkali metal salts of polyacrylic acid or polymethacrylic acid, for example those having a relative molecular weight of 500 to 70,000 g/mol.

For purposes of this document, the molecular weights indicated for polymeric polycarboxylates are weight-averaged molecular weights M_{w} of the respective acid form, which were always determined by gel permeation chromatography (GPC) using a UV detector. The measurement was performed against an external polyacrylic acid standard that, because of its structural kinship with the polymers being examined, provides realistic molecular weight values. These data deviate considerably from the molecular weight data when polystyrene sulfonic acids are used as the standard. The molar weights measured against polystyrene sulfonic acids are usually much higher than the molar weight indicated in this document.

Suitable polymers are, in particular, polyacrylates that preferably have a molecular weight of 2000 to 20,000 g/mol. Of this group in turn, the short-chain polyacrylates having molar weights from 2000 to 10,000 g/mol, and particularly preferably from 3000 to 5000 g/mol, may be particularly preferred because of their superior solubility.

Suitable polymers can also encompass substances that partially or entirely comprise units of vinyl alcohol or its derivatives.

Copolymeric polycarboxylates, in particular those of acrylic acid with methacrylic acid and of acrylic acid or methacrylic acid with maleic acid, are also suitable. Copolymers of acrylic acid with maleic acid containing from 50 to 90 wt % acrylic acid and from 50 to 10 wt % maleic acid have proven particularly suitable. Their relative molecular weight in terms of free acids is generally 2000 to 70,000 g/mol, preferably 20,000 to 50,000 g/mol, and in particular 30,000 to 40,000 g/mol. The (co)polymeric polycarboxylates can be used as either an aqueous solution or preferably a powder.

To improve water solubility, the polymers can also contain allyl sulfonic acids, for example allyl oxybenzenesulfonic acid and methallyl sulfonic acid as in EP-B-0 727 448, as monomers.

Further preferred copolymers are those that are described in German Patent Applications DE-A-43 03 320 and DE-A-44 17 734 and preferably comprise acrolein and acrylic acid/acrylic acid salts, or acrolein and vinyl acetate, as monomers.

Polymeric aminodicarboxylic acids, their salts, or their precursor substances may likewise be mentioned as additional preferred builder substances. Particularly preferred are polyaspartic acids and their salts and derivatives, concerning which German Patent Application DE-A-195 40 086 discloses that they exhibit not only cobuilder properties but also a bleach-stabilizing effect. Also suitable are polyvinylpyrrolidones and polyamine derivatives such as quaternized and/or ethoxylated hexamethylenediamines.

Further suitable builder substances are polyacetals that can be obtained by reacting dialdehydes with polyol carboxylic acids having 5 to 7 carbon atoms and at least three hydroxyl groups, as described e.g. in European Patent Application EP-A-0 280 223. Preferred polyacetals are obtained from dialdehydes such as glyoxal, glutaraldehyde, terephthalaldehyde and mixtures thereof, and from polyol carboxylic acids such as gluconic acid and/or glucoheptonic acid.

Also suitable as organic builder substances are dextrins, for example oligomers or polymers of carbohydrates, which can be obtained by partial hydrolysis of starches. The hydrolysis can be performed using ordinary, for example acid- or enzyme-catalyzed, methods. The hydrolysis products preferably have average molar weights in the range from 400 to 500,000 g/mol. A polysaccharide having a dextrose equivalent (DE) in the range from 0.5 to 40, in particular from 2 to 30, is preferred, DE being a common indicator of the reducing power of a polysaccharide as compared with dextrose, which possesses a DE of 100. Maltodextrins having a DE of between 3 and 20 and dry glucose syrups having a DE of between 20 and 37, as well as so-called yellow dextrins and white dextrins having higher molar weights in the range from 2000 to 30,000 g/mol, are usable. A preferred dextrin is described in British Patent Application 94 19 091.

Relevant oxidized derivatives of such dextrins are their reaction products with oxidizing agents that are capable of oxidizing at least one alcohol function of the saccharide ring to a carboxylic acid function. Oxidized dextrins of this kind, and methods for their manufacture, are known e.g. from European Patent Applications EP-A-0 232 202, EP-A-0 427 349, EP-A-0 472 042, and EP-A-0 542 496, and International Patent Applications WO-A-92/18542, WO-A-93/08251, WO-A-93/16110, WO-A-94/28030, WO-A-95/07303, WO-A-95/12619, and WO-A-95/20608. Also suitable is an oxidized oligosaccharide according to German Patent Application DE-A-196 00 018. A product oxidized at C₆ of the saccharide ring can be particularly advantageous.

Oxydisuccinates and other derivatives of disuccinates, preferably ethylenediamine disuccinate, are additional suitable cobuilders. Ethylenediamine-N,N′-disuccinate (EDDS), synthesis of which is described e.g. in U.S. Pat. No. 3,158,615, is preferably used in the form of its sodium or magnesium salts. Also preferred in this context are glycerol disuccinates and glycerol trisuccinates, such as those described e.g. in U.S. Pat. Nos. 4,524,009, 4,639,325, in European Patent Application EP-A-0 150 930, and in Japanese Patent Application JP-A-93/339 896. Suitable quantities for use in zeolite- and/or silicate-containing formulations are 3 to 15 wt %.

Further usable organic cobuilders are, for example, acetylated hydroxycarboxylic acids and their salts, which may optionally also be present in lactone form and which contain at least 4 carbon atoms and at least one hydroxy group, as well as a maximum of two acid groups. Cobuilders of this kind are described, for example, in International Patent Application WO 95/20029.

The agents according to the present invention can optionally contain detergency builders in quantities of 1 to 30 wt %, preferably 10 to 25 wt %.

The agents according to the present invention can contain bleaching agents.

Among the compounds that serve as bleaching agents and yield H₂O₂ in water, sodium percarbonate, sodium perborate tetrahydrate, and sodium perborate monohydrate are particularly important. Other usable bleaching agents are, for example, peroxopyrophosphates, citrate perhydrates, and per-acid salts or per-acids that yield H₂O₂, for example persulfates and persulfuric acid, respectively. Also usable is the urea peroxohydrate percarbamide, which can be described by the formula H₂N—CO—NH₂.H₂O₂. Especially when the agents are used for cleaning hard surfaces, for example for automatic dishwashing, they can also, if desired, contain bleaching agents from the group of the organic bleaching agents, although in principle their use is also possible in agents for textile washing. Typical organic bleaching agents are the diacyl peroxides, for example dibenzyol peroxide. Further typical organic bleaching agents are the peroxy acids, the alkyl peroxy acids and aryl peroxy acids being mentioned in particular as examples. Preferred representatives are peroxybenzoic acid and its ring-substituted derivatives, such as alkyl peroxybenzoic acids, but peroxy-α-naphthoic acid and magnesium monoperphthalate, the aliphatic or substituted aliphatic peroxy acids, such as peroxylauric acid, peroxystearic acid, ε-phthalimidoperoxyhexanoic acid (PAP), o-carboxybenzamidoperoxyhexanoic acid, N-nonenylamidoperoxyadipic acid, and N-nonenylamidopersuccinates, and aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane 1,4-diacid, N,N-terephthaloyl-di(6-aminoperhexanoic acid) can also be used. In particularly preferred fashion, the agents according to the present invention can contain phthalimidoperoxyhexanoic acid (PAP).

The bleaching agents can be gel-coated in order to protect them against premature decomposition.

The agents according to the present invention can contain bleach activators.

Compounds that, under perhydrolysis conditions, yield aliphatic peroxocarboxylic acids having preferably from 1 to 10 carbon atoms, in particular from 2 to 4 carbon atoms, and/or optionally substituted perbenzoic acid, can be used as bleach activators. Substances that can carry O— and/or N-acyl groups having the aforesaid number of carbon atoms, and/or optionally substituted benzoyl groups, are suitable. Multiply acylated alkylenediamines, in particular tetraacetylethylenediamine (TAED), acylated triazine derivatives, in particular 1,5-diacetyl-2,4-dioxohexahydro-1,3,5-triazine (DADHT), acylated glycourils, in particular tetraacetylglycouril (TAGU), N-acylimides, in particular N-nonanoyl succinimide (NOSI), aceylated phenolsulfonates, in particular n-nonanoyl- or isononanoyl oxybenzenesulfonate (n- and iso-NOBS), carboxylic acid anhydrides, in particular phthalic acid anhydride, acylated polyvalent alcohols, in particular triacetin, triethylacetyl citrate (TEAC), ethyleneglycol diacetate, 2,5-diacetoxy-2,5-dihydrofuran, and the enolic esters known from German Patent Applications DE 196 16 693 and DE 196 16 767, as well as acetylated sorbitol and mannitol and their respective mixtures (SORMAN) described in European Patent Application EP 0 525 239, acylated sugar derivatives, in particular pentaacetyl glucose (PAG), pentaacetyl fructose, tetraacetyl xylose, and octaacetyl lactose, as well as acetylated, optionally N-alkylated glucamine and gluconolactone, and/or N-acylated lactams, for example N-benzoyl caprolactam, that are known from International Patent Applications WO 94/27970, WO 94/28102, WO 94/28103, WO 95/00626, WO 95/14759, and WO 95/17498, are preferred. The hydrophilically substituted acylacetals known from German Patent Application DE 196 16 769, and the acyl lactams described in German Patent Application DE 196 16 770 and International Patent Application WO 95/14075, are also used in preferred fashion. The combinations of conventional bleach activators known from German Patent Application DE 44 43 177 can also be used. A further class of preferred liquid bleach activators are the liquid imide bleach activators of the following formula.

The agents according to the present invention can contain electrolytes.

A large number of very varied salts from the group of the inorganic salts can be used as electrolytes. Preferred cations are the alkali and alkaline-earth metals; preferred anions are the halides and sulfides. From a production-engineering standpoint, the use of NaCl or MgCl₂ in the agents according to the present invention is preferred. The proportion of electrolytes in the agents according to the present invention is usually 0.5 to 5 wt %.

The agents according to the present invention can contain pH-adjusting agents.

The use of pH-adjusting agents may be indicated in order to bring the pH of the agents according to the present invention into the desired range. All known acids and bases are usable here, provided their use is not prohibited for applications-engineering reasons or in the interest of user safety. The quantity of such adjusting agents usually does not exceed 2 wt % of the entire formulation.

The agents according to the present invention can contain colorants and fragrances.

Colorants and fragrances are added to the agents according to the present invention in order to improve the esthetic impression of the product and to make available to the user, in addition to washing or cleaning performance, a product that is visually and sensorially “typical and unmistakable.” Individual aroma compounds, e.g. synthetic products of the ester, ether, aldehyde, ketone, alcohol, and hydrocabon types, can be used as perfume oils or fragrances. Aroma compounds of the ester type are, for example, benzyl acetate, phenoxyethyl isobutyrate, p-tert-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate, and benzyl salicylate. The ethers include, for example, benzylethyl ether; the aldehydes e.g. the linear alkanals having 8 to 18 carbon atoms, citral, citronellal, citronellyloxyacetaldehyde, cyclamenaldehyde, hydroxycitronellal, lilial, and bourgeonal; the ketones, for example, the ionones, α-isomethylionone, and methylcedryl ketone; the alcohols, anethol, citronellol, eugenol, geraniol, linalool, phenylethyl alcohol, and terpineol; the hydrocarbons include principally the terpenes such as limonene and pinene. Preferably, however, mixtures of different aromas that together produce an appealing fragrance note are used. Perfume oils of this kind can also contain natural aroma mixtures such as those accessible from plant sources, for example pine, citrus, jasmine, patchouli, rose, or ylang-ylang oil. Also suitable are nutmeg oil, salvia oil, chamomile oil, melissa oil, mint oil, cinnamon leaf oil, linden blossom oil, juniper oil, vetiver oil, olibanum oil, galbanum oil, and labdanum oil, as well as orange-blossom oil, neroli oil, orange-peel oil, and sandalwood oil.

The agents according to the present invention can contain UV absorbers.

The agents can contain UV absorbers that are absorbed onto the treated textiles and improve the light resistance of the fibers and/or the light resistance of the other formulation constituents. “UV absorbers” are understood as organic substances (light protection filters) that are capable of absorbing ultraviolet radiation and re-emitting the absorbed energy in the form of longer-wave radiation, e.g. heat compounds that exhibit these desired properties are, for example, the compounds and derivatives of benzophenone, with substituents in the 2- and/or 4-position, that become effective by radiationless deactivation. Also suitable are substituted benzotriazols, for example water-soluble benzensulfonic acid-3-(2H-benztotriazol-2-yl)-4-hydroxy-5-(methylpropyl) monosodium salt (Cibafast® H), acrylates phenyl-substituted in the 3-position (cinnamic acid derivatives), optionally with cyano groups in the 2-position, salicylates, organic Ni complexes, and natural substances such as umbelliferon and body-derived urocanic acid. Particularly important are biphenyl and especially stilbene derivates, such as those described e.g. in EP 0 728 749 A and available commercially as Tinosorb® FD or Tinosorb® FR from Ciba. To be mentioned as UV-B absorbers are 3-benzylidene camphor and 3-benzylidene norcamphor and its derivatives, e.g. 3-(4-methylbenzylidene) camphor, as described in EP 0 693 471 B1; 4-aminobenzoic acid derivatives, preferably 4-(dimethylamino)benzoic acid 2-ethylhexyl ester, 4-(dimethylamino)benzoic acid 2-octyl ester, and 4-(dimethylamino)benzoic acid amyl ester; esters of cinnamic acid, preferably 4-methoxycinnamic acid 2-ethylhexyl ester, 4-methoxycinnamic acid propyl ester, 4-methoxycinnamic acid isoamyl ester, 2-cyano-3,3-phenylcinnamic acid 2-ethylhexyl ester (octocrylene); esters of salicylic acid, preferably salicylic acid 2-ethylhexyl ester, salicylic acid 4-isopropylbenzyl ester, salicylic acid homomenthyl ester; benzophenone derivatives, preferably 2-hydroxy4-methoxybenzophenone, 2-hydroxy-4-methoxy-4′-methylbenzophenone, 2,2′-dihydroxy-4-methoxybenzophenone; esters of benzalmalonic acid, preferably 4-methoxybenzalmalonic acid di-2-ethylhexyl ester; triazine derivatives, for example 2,4,6-trianilino-(p-carbo-2′-ethyl-1′-hexyloxy)-1,3,5-triazine and octyl triazone as described in EP 0 818 450 A1, or dioctyl butamido triazone (Uvasorb® HEB); propane-1,3-diones, for example 1-(4-tert-butylphenyl)-3-(4′-methoxyphenyl)-propane-1,3-dione; ketotricyclo(5.2.1.0)decane derivatives, such as those described in EP 0 694 521 B1. Also suitable are 2-phenylbenzimidazole-5-sulfonic acid and its alkali, alkaline-earth, ammonium, alkylammonium, alkanolammonium, and glucammonium salts; sulfonic acid derivatives of benzophenones, perferably 2-hydroxy4-methoxybenzophenone-5-sulfonic acid and its salts; sulfonic acid derivatives of 3-benzylidene camphor, for example 4-(2-oxo-3-bornylidenemethyl)benzenesulfonic acid and 2-methyl-5-(2-oxo-3-bornylidene)sulfonic acid and its salts.

Typical UV-A filters that are suitable are, in particular, derivatives of benzoyl methane, for example 1-(4′-tert-butylphenyl)-3-(4′-methoxyphenyl)propane-1,3-dione, 4-tert-butyl-4′-methoxydibenzoyl methane (Parsol 1789), 1-phenyl-3-(4′-isopropylphenyl)propane-1,3-dione, and enamine compounds as described in DE 197 12 033 A1 (BASF). The UV-A and UV-B filters can, of course, also be used in mixtures. In addition to the aforementioned soluble substances, insoluble light-protection pigments, namely finely dispersed, preferably nanoized metal oxides or salts, are also possible for this purpose. Examples of suitable metal oxides are, in particular, zinc oxide and titanium oxide, and also oxides of iron, zirconium, silicon, manganese, aluminum, and cerium, as well as mixtures thereof. Silicates (talc), barium sulfate, or zinc stearate can be used as salts. The oxides and salts are already used in the form of pigments for skin-care and skin-protection emulsions and decorative cosmetics. The particles should have an average diameter of less than 100 nm, preferably between 5 and 50 nm, and in particular between 15 and 30 nm. They can have a spherical shape, but particles of this kind that possess an ellipsoidal shape, or one otherwise deviating from the spherical conformation, can also be used. The pigments can also be present in surface-treated form, i.e. hydrophilized or hydrophobized. Typical examples are gel-coated titanium dioxides, for example titanium dioxide T 805 (Degussa) or Eusolex® T2000 (Merck). Suitable as hydrophobic coating agents are, especially, silicones and especially trialkoxy octylsilanes or simethicones. Micronized zinc oxide is preferably used. Further suitable UV light protection filters may be inferred from the overview by P. Finkel in SÖFW-Journal 122, 543 (1996).

UV absorbers are usually used in quantities of 0.01 wt % to 5 wt %, preferably 0.03 wt % to 1 wt %.

The agents according to the present invention can contain crease-prevention agents.

Because textile fabrics, in particular those made of rayon, wool, cotton, and mixtures thereof, can tend to crease because the individual fibers are sensitive to bending, kinking, pressing, and squeezing transversely to the fiber direction, the agents can contain synthetic crease-protection agents. These include, for example, synthetic products based on fatty acids, fatty acid esters, fatty acid amides, alkylol esters, or alkylolamides, or fatty alcohols that are usually reacted with ethylene oxides, or products based on lecithin -or modified phosphoric acid esters.

The agents according to the present invention can contain graying inhibitors.

The purpose of graying inhibitors is to keep dirt that has been detached from the fibers suspended in the washing bath, and thus prevent it from redepositing. Water-soluble colloids, usually organic in nature, are suitable for this, for example glue, gelatin, salts of ethersulfonic acids of starch or of cellulose, or salts of acid sulfuric acid esters of cellulose or of starch. Water-soluble polyamides containing acid groups are also suitable for this purpose. Soluble starch preparations, and starch products other than those cited above, can also be used, for example degraded starch, aldehyde starches, etc. Polyvinylpyrrolidone is also usable. Cellulose ethers such as carboxymethylcellulose (Na salt), methylcellulose, hydroxyalkylcellulose, and mixed ethers such as methylhydroxyethylcellulose, methylhydroxypropylcellulose, methylcarboxymethylcellulose, are preferred, however.

In a particularly preferred embodiment, the textile care agent, preferably a liquid washing agent, is present as a portion in an entirely or partially water-soluble envelope. Portioning facilitates measurement by the user.

The textile care agents are present, for example, packaged in film pouches. Film pouches made of water-soluble film make it unnecessary for the user to tear open the package. This makes possible convenient addition of a single portion measured out for one washing operation, by placing the pouch directly into the washing machine or putting the pouch into a specific quantity of water, for example in a bucket, a bowl, or a sink for hand washing or rinsing. The film pouch surrounding the washing portion dissolves without residue once a certain temperature is reached. Washing agents packaged in pouches made of water-soluble film are also described in large numbers in the existing art. The earlier patent application DE 198 31 703, for example, discloses a portioned washing or cleaning agent preparation in a pouch made of water-soluble film, in particular in a pouch made of (optionally acetalized) polyvinyl alcohol (PVA), in which at least 70 wt % of the particles of the washing or cleaning agent preparation have particle sizes >800 μm.

Numerous methods for producing water-soluble washing agent portions already exist in the related art, those methods being incorporated in the context of this application. The best-known methods are the tubular film methods using horizontal and vertical sealing seams. Also suitable for the production of film pouches or even dimensionally stable washing agent portions is the thermoforming (deep drawing) method, as described e.g. in WO-A1 00/55068.

The water-soluble envelopes need not necessarily be made of a film material, but can also represent dimensionally stable containers that are obtained, for example, by means of an injection molding process.

A known method for the production of water-soluble hollow injection-molded elements containing washing and/or cleaning agents is described, for example, in WO-A1 01/36290.

Also known in the existing art are methods for the production of water-soluble capsules from polyvinyl alcohol or gelatin, which methods offer in principle the possibility of making available capsules with a high filling ratio. The methods are based on introduction of the water-soluble polymer into a shape-defining cavity. Filling and sealing of the capsules is accomplished either synchronously or in successive steps; in the latter case, filling takes place through a small opening. Methods in which filling and sealing proceed concurrently are described, for example, in WO 97/35537. Filling of the capsules is accomplished by way of a filling wedge that is arranged above two drums, rotating in opposite directions, that have semi-spherical concavities on their surface. The drums convey polymer strips that cover the semispherical cavities. Sealing takes place at the positions at which the polymer strip of the one drum encounters the polymer strip of the opposite drum. Concurrently therewith, the contents are injected into the capsule as it is being formed, the injection pressure of the liquid contents pressing the polymer strips into the semispherical concavities.

A method for the production of water-soluble capsules in which first filling and then sealing is accomplished is disclosed in WO 01/64421. The production process is based on the so-called Bottle Pack® method, as described e.g. in German Unexamined Application DE 14 114 69. Here a tube-like preform is guided into a two-part cavity. The cavity is closed, sealing the lower tube segment; the tube is then inflated to create the capsule shape in the cavity, filled, and then sealed.

The envelope material used to produce the water-soluble portion is preferably a water-soluble thermoplastic polymer, particularly preferably selected from the group of (optionally partially acetalized) polyvinyl alcohol, polyvinyl alcohol copolymers, polyvinylpyrrolidone, polyethylene oxide, gelatin, cellulose and its derivatives, starch and its derivatives, blends, and compounds, inorganic salts, and mixtures of the aforesaid materials, preferably hydroxypropylmethylcellulose and/or polyvinyl alcohol blends.

In a particularly preferred embodiment, the envelope material is made entirely or partially of the copolymers to be introduced according to the present invention into the textile care agents. The polyvinyl alcohols described above are commercially available, for example under the trade name Mowiol® (Clariant). Polyvinyl alcohols that are particularly suitable in the context of the present invention are, for example, Mowiol® 3-83, Mowiol® 4-88, Mowiol® 5-88, Mowiol® 8-88, and Clariant L648.

Further polyvinyl alcohols particularly suitable as materials for the hollow elements may be inferred from the table below:

| | Degree of | Molar weight | Melting point |
|---|---|---|---|
| Designation | hydrolysis (%) | (kDa) | (° C.) |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23,600 | 100 |
| Gohsefimer ® LL02 | 41-51 | 17,700 | 100 |

Further polyvinyl alcohols suitable as materials for the envelope are ELVANOL® 51-05, 52-22, 50-42, 85-82, 75-15, T-25, T-66, 90-50 (trademark of DuPont), ALCOTEX® 72.5, 78, B72, F80/40, F88/4, F88/26, F88/40, F88/47 (trademark of Harlow Chemical Co.), Gohsenol® NK-05, A-300, AH-22, C-500, GH-20, GL-03, GM-14L, KA-20, KA-500, KH-20, KP-06, N-300, NH-26, NM1 1Q, KZ-06 (trademark of Nippon Gohsei K. K.).

The water-soluble thermoplastic used to produce the portion according to the present invention can additionally comprise polymers selected from the group encompassing acrylic acid-containing polymers, polyacrylamides, oxazoline polymers, polystyrene sulfonates, polyurethanes, polyesters, polyethers, and/or mixtures of the above polymers.

It is preferred if the water-soluble thermoplastic used encompasses a polyvinyl alcohol whose degree of hydrolysis is equal to 70 to 100 mol %, preferably from 80 to 90 mol %, particularly preferably from 81 to 89 mol %, and in particular from 82 to 88 mol %.

It is further preferred that the water-soluble thermoplastic used encompass a polyvinyl alcohol whose molecular weight is in the range from 10,000 to 100,000 gmol⁻¹, preferably from 11,000 to 90,000 gmol⁻¹, particularly preferably from 12,000 to 80,000 gmol⁻¹, and in particular from 13,000 to 70,000 gmol⁻¹.

It is additionally preferred if the thermoplastics are present in quantities of at least 50 wt %, preferably at least 70 wt %, particularly preferably at least 80 wt %, and in particular at least 90 wt %, in each case in terms of the weight of the water-soluble thermoplastic polymer.

The thermoplastic polymers can contain plasticizing agents to improve their processability. This can be advantageous in particular when polyvinyl alcohol or partially hydrolyzed polyvinyl acetate was selected as the polymer material for the portion. Glycerol, triethanolamine, ethylene glycol, propylene glycol, diethylene or dipropylene glycol, diethanolamine, and methyidiethylamine have proven particularly successful as plasticizing adjuvants.

It is advantageous if the thermoplastic polymers contain plasticizing adjuvants in quantities of at least >0 wt %, preferably ≧10 wt %, particularly preferably ≧20 wt %, and in particular ≧30 wt %, in each case in terms of the weight of the envelope material.

A further subject of the invention is the use of a copolymer to be utilized according to the present invention in a textile care agent in order to reduce fluffing.

A further subject of the invention is the use of a copolymer to be utilized according to the present invention in a textile care agent in order to decrease pilling of textile fabrics.

A further subject of the invention is the use of a copolymer to be utilized according to the present invention in a textile care agent in order to facilitate the ironing of textile fabrics.

It has moreover been found, surprisingly, that the copolymers to be utilized according to the present invention not only reduce creasing and ensure a smooth textile surface, but in addition considerably improve the softness of the treated textiles.

A further subject of the invention is therefore the use of a copolymer to be utilized according to the present invention in a textile care agent in order to reduce creasing in, smooth, and improve the softness of textile fabrics.

A further subject of the invention is a conditioning substrate, which is a substrate that is impregnated and/or soaked with the textile care agent according to the present invention.

The substrate material comprises porous materials that are capable of reversibly absorbing and discharging an impregnation fluid. Suitable for this are both three-dimensional structures, for example sponges, but preferably porous, planar cloths. They can be made of a fibrous or cellular flexible material that exhibits sufficient thermal stability for use in a dryer, and can retain sufficient quantities of an impregnation or coating agent in order to condition materials effectively with no occurrence of appreciable dripping or bleeding of the agent during storage. These cloths include cloths made of woven and nonwoven synthetic and natural fibers, felt, paper, or foam, such as hydrophilic polyurethane foam.

Conventional cloths made of nonwoven material (nonwoven fabrics) are preferably used here. Nonwoven fabrics are defined in general as adhesively bonded fibrous products that comprise a mat or a layered fiber structure, or those that encompass fiber mats in which the fibers are distributed randomly or in a statistical arrangement. The fibers can be natural, such as wool, silk, jute, hemp, cotton, linen, sisal, or ramie; or synthetic, such as rayon, cellulose esters, polyvinyl derivatives, polyolefins, polyamides, viscoses, or polyesters. In general, any fiber diameter or titer is suitable for the present invention. Preferred conditioning substrates according to the present invention are made of a nonwoven material that contains cellulose. Because of the random or statistical arrangement of fibers in the nonwoven material, which impart excellent strength in all directions, the nonwoven materials used here have no tendency to tear or disintegrate when they are used, for example, in an ordinary household clothes dryer. Examples of nonwoven materials that are suitable as substrates in the present invention are known, for example, from WO 93/23603. Preferred porous and planar conditioning cloths are made of one or several fiber materials, in particular of cotton, finished cotton, polyamide, polyester, or mixtures thereof. The conditioning substrates in cloth form preferably have an area of 0.2 to 0.005 m², preferably of 0.15 to 0.01 m², in particular of 0.1 to 0.03 cm², and particularly preferably of 0.09 to 0.06 m². The gram weight of the material is usually between 20 and 500 g/m², preferably from 25 to 200 g/m², in particular from 30 to 100 g/m², and particularly preferably from 40 to 80 g/m².

A further subject of the invention is a conditioning method for conditioning wet textiles by means of the conditioning substrate according to the present invention.

The conditioning method is performed by introducing the conditioning substrate into a textile drying operation together with wet textiles that derive, for example, from a previous washing operation. The textile drying operation usually takes place in an apparatus for drying textiles, preferably in a household clothes dryer.

A further subject of the invention is a method for reducing the fluffing of textile fabrics by bringing textile fabrics into contact with a textile care agent according to the present invention and/or a conditioning substrate according to the present invention in a textile cleaning process and/or textile drying process.

The conditioning substrates according to the present invention can be placed directly, with the wet laundry, into a household clothes dryer and/or a washing machine.

The textile care agents according to the present invention are produced by simply mixing together and stirring the individual components, as is familiar to one skilled in the art. The copolymers to be utilized according to the present invention can be mixed into the agent as a solution, preferably as an aqueous solution, and/or as a dry powder, preferably absorbed onto a washing agent constituent, compounded or granulated, mixed or tabletted or pelletized, as carrier. In the case of preferred esterquat-containing liquid formulations, the esterquats are first melted and the melt is then incorporated, using a highly dispersing stirring tool, into a preferably aqueous, preferably preheated formulation.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

### EXAMPLES

Table 1 shows formula E1 according to the present invention as well as comparison formula V1. All information is in weight percent, in each case in terms of the agent as a whole.

TABLE 1

| Raw material | E1 | E2 | V1 |
|---|---|---|---|
| Sodium alkyl benzylsulfonate | 11.43 | 11.43 | 11.43 |
| Enzyme (protease, amylase, cellulase) | 0.7 | 0.7 | 0.7 |
| Perfume | 0.32 | 0.32 | 0.32 |
| C₁₂-C₁₈ fatty alcohol + 7 EO | 2.7 | 2.7 | 2.7 |
| Hydroxyethane-1,1-diphosphonic acid | 0.74 | 0.74 | 0.74 |
| Hydroxypropane-1,2,3-tricarboxylic acid | 1.0 | 1.0 | 1.0 |
| * 1H₂O | | | |
| Paraffin | 0.44 | 0.44 | 0.44 |
| Sodium carbonate | 20.5 | 20.5 | 20.5 |
| Sodium carbonate peroxohydrate | 13.0 | 13.0 | 13.0 |
| Sodium hydrogencarbonate | 5.0 | 5.0 | 5.0 |
| Sodium hydroxide | 0.5 | 0.5 | 0.5 |
| Sodium silicate 2.0^{[a]} | 4.7 | 4.7 | 4.7 |
| Sodium sulfate | 26.8 | 26.8 | 26.8 |
| Polyacrylate | 3.0 | 3.0 | 3.0 |
| Soap (C₁₆-C₂₂ fatty acid Na salt) | 1.0 | 1.0 | 1.0 |
| TAED^{[b]} | 2.6 | 2.6 | 2.6 |
| Water | 2.31 | 2.31 | 2.31 |
| Polymer A^{[c]} | 0.4 | 0.8 | — |
| other ingredients | to make | to make | to make |
| | 100 | 100 | 100 |

^{[a]}Amorphous water glass having a (SiO2:Na2O) ratio of 2:1
^{[b]}Tetraacetylethylenediamine
^{[c]}Starch-based graft copolymer grafted with acrylic acid (average degree of substitution per carbohydrate unit: 2.6; average graft chain length: 3 acrylic acid units).

I) Determining the Force to be Exerted for Flattening Textiles (Ease of Ironing)

To determine the sliding frictional force that must be exerted in order to flatten a textile, the following experimental arrangement was constructed: A commercially available Rowenta P2 Professional clothes iron was pulled by a Zwick (model 2.5/TN1P) universal testing machine, via a reversing roller, over the fabric in the longitudinal direction at a speed of 800 mm per minute. The temperature of the iron was set at level III. The contact weight of the iron, weighing 1680 g, was increased to 2940 g using additional weights. The force (in N) needed to move the iron was measured.

The test fabrics (textile: bleached cotton cloth; 100% cotton; 1.2*0.2 m) were treated with formulas El and E2, and with the comparison formula V1 without the textile care component, as follows:

Six strips of fabric were washed with 109 g of each formulation (water hardness: 16° dH) (Miele Novotronik W918; washing program: Standard Cotton/Color 60° C./Spin: 900 rpm), and then dried (line-dried for two days in a climate-controlled room at 20° C. and 65% relative humidity).

The washing and drying cycles were each repeated three times.

Table 2 shows the measured sliding frictional forces as a function of the test fabrics treated with the formulas:

TABLE 2

| | Test fabric treated with | | |
|---|---|---|---|
| | E1 | E2 | V1 |
| Measured force (N) | 9.8 | 8.0 | 13 |

A definite improvement in ease of ironing is obtained for formulations E1 and E2 according to the present invention, as compared with V1.

II) Determining the Degree of Creasing in Textiles

Creasing was determined on the basis of AATCC (American Association of Textile and Color Chemistry) Test 124. Creasing was evaluated after the washing and subsequent drying process, a panel of five persons evaluating the creasing of the test fabrics against standard creased fabrics (AATCC124). A score of 5 is assigned to crease-free fabrics, and a score of 1 to highly creased fabrics. The total score constitutes the arithmetic mean of the evaluations.

The test fabrics (textile: bleached cotton cloth; 100% cotton; 1.0 m*0.9 m) were treated with formula E1 and with the comparison formula V1 having no textile care component, as follows:

Three pieces of fabric were washed with 109 g of each formulation (water hardness: 16° dH) (Miele Novotronik W918; washing program: Standard Cotton/Color 60° C./Spin: 900 rpm), and then dried (line-dried for two days in a climate-controlled room at 20° C. and 65% relative humidity).

The washing and drying cycles were each repeated three times.

Table 3 shows the creasing evaluation of the test fabrics as a function of the formulas:

TABLE 3

Test fabric treated with

| | E1 | V1 |
|---|---|---|
| Crease evaluation (score) | 2.1 | 1.4 |

Creasing was found to be definitely reduced for formula E1 according to the present invention as compared with V1.

Textile care agents according to the present invention that are present as liquid washing agents are, for example E3 through E5, the compositions of which are reproduced in Table 4.

TABLE 4

| Raw material | E3 | E4 | E5 |
|---|---|---|---|
| APG 600^{[a]} | 1.5 | — | — |
| Defoamer^{[b]} | 0.03 | 0.03 | 0.03 |
| Glycerol | 5.0 | — | — |
| Diethylene glycol | 0.5 | — | — |
| Propylene-1,2-glycol | — | 5 | 5 |
| Ethanol | — | 2.5 | 2.3 |
| Texapon N70^{[c]} | 5 | 5 | 5 |
| Dehydol LT7^{[d]} | 12 | 13 | 12 |
| Boric acid | 0.25 | 1 | 1 |
| Sodium formate | 1.5 | — | — |
| Sodium citrate × 2H₂O | — | 2 | 4 |
| Sodium hydroxide | 0.85 | 0.85 | 1.5 |
| Lauric acid | 3 | 3 | 6 |
| Oleic acid | 1.5 | 1.5 | 2.4 |
| Zinc ricinoleate | 0.5 | 0.5 | — |
| Acusol 820^{[e]} | 0.2 | — | — |
| Dequest 2066^{[f]} | 0.5 | 0.5 | 0.03 |
| Polyvinylpyrrolidone | 0.1 | 0.1 | 0.4 |
| Protease | 0.4 | 0.4 | 0.4 |
| Amylase | — | 0.1 | 0.1 |
| Perfume | 0.7 | 0.7 | 0.7 |
| Polymer A^{[g]} | 5.0 | 3.5 | 1.5 |
| Water | to make | to make | to make |
| | 100 | 100 | 100 |

^{[a]}C₁₂₋₁₆ fatty alcohol-1,4-glucoside
^{[b]}Dimethylpolysiloxane emulsifier mixture (Dow)
^{[c]}C₁₂₋₁₄ ether sulfate with 2 EO (Cognis)
^{[d]}C₁₂₋₁₈ fatty alcohol + 7 EO (Cognis)
^{[e]}Methacrylic acid(stearyl alcohol 20 EO)ester/acrylic acid copolymer (Cognis)
^{[f]}Diethylenetriamine pentamethylene phosphonic acid sodium salt (Monsanto)
^{[g]}Starch-based graft copolymer grafted with acrylic acid (average degree of substitution per carbohydrate-unit: 2.6; average graft chain length: 3 acrylic acid units).

Table 5 shows the formulation of a textile care agent according to the present invention that is present as delicate fabric washing agent E6.

TABLE 5

| Raw material | E6 |
|---|---|
| APG 600 | 2.5 |
| Ethylene glycol distearate | 0.3 |
| Ethanol | 0.37 |
| Cetylstearyl alcohol sulfate sodium salt | 0.47 |
| Dehydol LT7 | 14.0 |
| Stepantex VA90^{[h]} | 2.5 |
| Citric acid | 0.05 |
| Cellulase | 0.04 |
| Perfume | 0.7 |
| Polymer A | 0.5 |
| Water | to make 100 |

^{[h]}N-methyl-N(2-hydroxyethyl)-N,N-(ditallowacyloxyethyl)ammonium methosulfate (Stepan)

Table 6 describes a textile care agent according to the present invention that is formulated as a nonaqueous liquid washing agent E7.

TABLE 6

| Raw material | E7 |
|---|---|
| Glycerol | 1 |
| Ethanol | 3.3 |
| C₁₂₋₁₄ fatty alcohol + EO + PO | 22.5 |
| Dodecylbenzenesulfonic acid isopropylamine salt | 24.5 |
| C₁₂₋₁₈ fatty acid | 17.5 |
| Dequest 2066 | 0.6 |
| Monoethanolamine | 4.9 |
| Protease | 1 |
| Amylase | 0.2 |
| Cellulase | 0.06 |
| Water | 6 |
| Perfume | 0.25 |
| Colorant | + |
| Polymer A | 5.0 |
| Propylene glycol | to make 100 |

Agents E3 through E7 according to the present invention exhibited reduced fluffing and pilling as compared with agents not according to the present invention that did not contain copolymers to be utilized according to the present invention.

A textile care agent that is formulated as a conditioner is, for example, E8, and a comparison formula is V1; their compositions are indicated in Table 7.

TABLE 7

Composition (wt %)

| | E8 | V2 |
|---|---|---|
| Rewoquat WE 18^{[a]} | 22.5 | 22.5 |
| Silicone oil^{[b]} | — | − |
| Tegopren 5843^{[c]} | 0.75 | − |
| MgCl₂.6H₂O | 0.5 | + |
| Polymer A | 5.0 | − |
| Perfume | 1.6 | + |
| Colorant | + | + |
| Water, deionized | to make 100 | to make 100 |

^{[a]}N-methyl-N(2-hydroxyethyl)-N,N-(ditallowacyloxyethyl)ammonium methosulfate (Stepan)
^{[b]}Silicone oil (Ciba)
^{[c]}Polyether-modified polysiloxane (Goldschmidt)

Formulation E8 was produced by melting the esterquat in water. The melted esterquat was then stirred with a high-dispersion device, and the remaining active ingredients were added. Perfume was added after the mixture had cooled to less than 30° C.

For the production of conditioning substrates, nonwoven cellulose fabrics (area: 24.5 cm×39 cm) were soaked in 20 g of conditioner E8 according to the present invention. A comparison substrate using formula V2 was produced analogously.

Fluffing and Pilling

3.5 kg of dry laundry, comprising six terrycloth hand towels, eight pillows, five dishtowels, 2 m of white 100%-cotton woven goods (shirt-quality), 2 m white 100%-polyester microfiber woven goods, 2 m white 100%-polyester microfiber jersey, 50 cm white 50%-cotton/50%-polyester poplin goods, 2 m white 100%-cotton single jersey, and two pairs of underpants, was washed with tower powder at 30° C. in a washing machine (Miele Novotronic W 985; normal wash, 30° C.) and then dried in a household clothes dryer (Miele Electronic T 352 C; foldable dry, wash-and-wear).

After the drying operation, the previously tared fluff filter of the dryer.

The wash-dry-weigh cycles were repeated ten times under the following conditions:
a) the textiles were dried without a conditioning substrate;
b) the textiles were placed in the dryer with a V1 conditioning substrate;
c) the textiles were placed in the dryer with an E8 conditioning substrate.

The weight of the fluff was determined after each drying cycle, and summed over the ten cycles. The results were a) 7.58 g, b) 8.39 g, and c) 5.51 g.

Utilization of the conditioning substrate thus considerably reduces fluffing and protects the textiles.

Investigations of pilling were conducted under the same conditions as set forth above. The investigations were performed in accordance with DIN EN ISO 12945 part 2, “Determination of the tendency of textile fabrics to fluff at the surface, and of pilling tendency,” using a Martindale Model 404 scrubbing and pilling test device. The investigations were performed in a climate-controlled room (textile temperature 20° C., relative humidity 65%). The principle of the Martindale test is that test articles are rubbed against a defined fabric in a constantly changing motion, which ensures that the surface fibers of the specimens are bent in all directions. The resulting pills on the surface of the test articles are evaluated, after a defined number of rotations, by visual comparison against a standard set. The scrubbing agent disks, 140 mm in diameter, are clamped over the scrubbing tables, backed by standard felt disks. The test articles (140 mm in diameter) are immobilized in special specimen holders and placed with the good side against the counterpart textile. The guide plate of the device is placed on top, and weighted spindles are introduced through the guide plate into the specimen holder located beneath. The drive mechanism comprises one inner and two outer drives, which force the guide plate of the specimen holder to describe a Lissajous figure. The Lissajous motion changes to a circular motion and to gradually narrowing ellipses that become a straight line, from which progressively widening ellipses develop in a diagonally opposite direction; the pattern then repeats.

The degree of pilling is ascertained by comparing the test article to prepared photographs of standard cloth.

The measurement showed that pilling on the textiles treated with conditioning substrate c) was greatly reduced as compared with the samples from a) and b).

Comparable results were observed when 36 ml of conditioner E8 according to the present invention were applied through the bleach dispenser of a washing machine, during the rinse cycle, onto the textiles to be conditioned. The textiles treated with formula V1 not according to the present invention exhibited much greater fluffing and pilling.

1. A textile care agent, comprising a copolymer of (a) one or more ethylenically unsaturated carboxylic acids and/or their salts and (b) one or more carbohydrates, the agent optionally further comprising one or more complexing agents.

2. The agent of claim 1, wherein (a) comprises one or more ethylenically unsaturated C₃-C₁₀ carboxylic acids, their alkali and/or ammonium salts, or any mixture thereof.

3. The agent of claim 2, wherein (a) comprises one or more C₃-C₆ carboxylic acids.

4. The agent of claim 2, wherein (a) comprises one or more α-β-unsaturated carboxylic acids.

5. The agent of claim 2, wherein (a) comprises one or more α-β-unsaturated C₃-C₆ carboxylic acids.

6. The agent of claim 1, wherein (a) is selected from the group consisting of acrylic acid, methacrylic acid, sodium, potassium, or ammonium salts thereof, and any mixtures thereof.

7. The agent of claim 1, wherein the carbohydrate is selected from the group consisting of oligo- and polysaccharides, starch, pectin, algin, chitin, chitosan, heparin, carrageenan, agar, gum arabic, tragacanth, karaya gum, ghatti gum, locust bean gum, guar gum, tara gum, inulin, xanthan, dextran, sucrose, nigeran, pentosanes, xylan, araban, starch polysaccharides, amyloses and degradation products thereof, dextrins, celluloses, xylans, arabans, galactans, and any mixtures or derivatives thereof.

8. The agent of claim 1, wherein the copolymer comprises a graft copolymer.

9. The agent of claim 8, wherein the graft copolymer has an average degree of substitution above 1.5.

10. The agent of claim 9, wherein the graft copolymer has an average degree of substitution above 2.

11. The agent of claim 10, wherein the graft copolymer has an average degree of substitution above 2.5.

12. The agent of claim 8, wherein each grafting site on the graft copolymer on average comprises more than one monomer unit of (a).

13. The agent of claim 12, wherein each grafting site on the graft copolymer on average comprises more than two monomer units of (a).

14. The agent of claim 13, wherein each grafting site on the graft copolymer on average comprises 2.5 to 5 monomer units of component (a).

15. The agent of claim 1, wherein the copolymer has an average molar weight above 1000 g/mol.

16. The agent of claim 15, wherein the copolymer has an average molar weight above 5000 g/mol.

17. The agent of claim 16, wherein the copolymer has an average molar weight above 10,000 g/mol.

18. The agent of claim 17, wherein the copolymer has an average molar weight above 15,000 g/mol.

19. The agent of claim 18, wherein the copolymer has an average molecular weight of 18,000 to 70,000 g/mol.

20. The agent of claim 19, wherein the copolymer has an average molecular weight of 20,000 and 65,000 g/mol.

21. The agent of claim 1, comprising at least 0.05% by weight of the copolymer.

22. The agent of claim 22, comprising 0.1 to 10 wt % of the copolymer.

23. The agent of claim 23, comprising 1 to 5 wt % of the copolymer.

24. The agent of claim 1, comprising one or more complexing agents.

25. The agent of claim 24, wherein the complexing agent comprises citric acid or a salt thereof.

26. The agent of claim 1, in powder, granulate, extrudate, pressed, melted shaped, liquid, dispersion, suspension, emulsion, solution, microemulsion, gel, or paste form.

27. The agent of claim 24, comprising up to 35 wt % of one or more nonionic surfactants.

28. The agent of claim 27, comprising one or more enzymes.

29. The agent of claim 28, comprising one or more softener components.

30. A conditioning substrate, comprising a substrate that is impregnated and/or soaked with a textile care agent according to claim 1.

31. A method of treating textile fabrics comprising contacting a textile fabric with an effective amount of the textile care agent of claim 1 in a textile cleaning process and/or textile drying process to reduce fluffing of said textile fabric.
